(19) United States
(12) Patent Application Publication
(10) Pub. No.: US 2022/0318545 A1
(43) Pub. Date: Oct. 6, 2022

(54) DETECTING TABLE INFORMATION IN ELECTRONIC DOCUMENTS

(71) Applicant: AT&T Intellectual Property I, L.P., Atlanta, GA (US)

(72) Inventors: Tyler Poff, Plano, TX (US); Vijayan Nagarajan, Plano, TX (US); Abhay Dabholkar, Allen, TX (US); Abhishek Mishra, Richardson, TX (US)

(21) Appl. No.: 17/222,412

(22) Filed: Apr. 5, 2021

(51) Int. Cl. G06K 9/00; G06K 9/46

(52) U.S. Cl. CPC G06K 9/00449; G06K 9/4604; G06K 9/00456; G06K 2209/01

(57) ABSTRACT

Techniques for processing of electronic documents comprising tables to desirably extract and/or recreate tables, including information in the tables, are presented. A document processing management component (DPMC) can perform a multi-stage process to extract a table from a document and recreate the table, including the table structure and information, in an editable form. During first stage, DPMC can identify candidate cells of the table based on analysis of the document, including identifying border lines that can represent cell borders, identifying any free floating candidate cells, and identifying characters of the candidate cells. During second stage, DPMC can determine structural relationships between respective candidate cells and respective neighbor candidate cells in all directions, based on applicable rules, and record the respective associations between those candidate cells. During third stage, DPMC can determine row/column placement and scaling of the candidate cells based on the respective associations and applicable rules.

### TECHNICAL FIELD

The subject disclosure relates generally to electronic document processing, e.g., to detecting table information in electronic documents.

### BACKGROUND

Physical documents can be scanned, photographed, or captured using devices, such as scanners (e.g., stand-alone scanner or printer/scanner), communication devices (e.g., mobile phones), or other devices with scanning or photographic capabilities. Typically, with regard to a scanned, photographed, or captured document, or an electronic document created using certain applications, the text and/or other features (e.g., tables) of such document are not editable or retrievable from or in such document because the text and/or other features, and the background, of the document are part of the same layer.

The above-described description is merely intended to provide a contextual overview relating to electronic document processing, and is not intended to be exhaustive.

### BRIEF DESCRIPTION OF THE DRAWINGS

FIG. 1 depicts a block diagram of an example, non-limiting system that can desirably process an electronic document comprising a table of data to desirably extract and recreate the table, including the table structure and the data in the table, to generate an editable and searchable electronic textual document comprising the recreated table, in accordance with various aspects and embodiments of the disclosed subject matter.

FIG. 2 depicts a block diagram of an example, non-limiting document processing management component (DPMC) that can perform and/or manage a multi-stage process for processing of electronic documents that can comprise tables of data to desirably extract and recreate the tables, including the table structure and the data in the tables, to generate an editable and searchable electronic textual documents comprising the recreated tables, in accordance with various aspects and embodiments of the disclosed subject matter.

FIG. 3 presents a diagram of an example, non-limiting electronic document that can comprise a table that can comprise various items of data, in accordance with various aspects and embodiments of the disclosed subject matter.

FIG. 4 depicts a diagram of an example, non-limiting image removal process for removal of the bordered candidate cells that can be associated with a table of an electronic document, in accordance with various aspects and embodiments of the disclosed subject matter.

FIG. 5 illustrates a diagram of an example, non-limiting text blocking process that can generate blocks from text in an electronic document, to facilitate identifying free floating candidate cells that can be associated with a table in the electronic document, in accordance with various aspects and embodiments of the disclosed subject matter.

FIG. 6 presents a diagram of an example electronic document that can be generated based at least in part on further processing of the electronic document presented in FIG. 5 to facilitate identifying respective textual information associated with respective bounding boxes, in accordance with various aspects and embodiments of the disclosed subject matter.

FIG. 7 depicts a diagram of an example electronic document that can be generated as a result of removing bounding boxes of information in the electronic document (e.g., of FIG. 6) that are determined to not be part of free floating candidate cells that can be associated with the table of the electronic document to facilitate identifying the free floating candidate cells, in accordance with various aspects and embodiments of the disclosed subject matter.

FIG. 8 presents a diagram of an example table at least provisionally containing a group of cells, comprising bordered candidate cells and free floating candidate cells, identified in an electronic document as a result of the analysis performed by the DPMC, in accordance with various aspects and embodiments of the disclosed subject matter.

FIG. 9 illustrates a block diagram of an example, non-limiting subgroup of candidate cells that can be part of a group of candidate cells that can be associated with a table of data of an electronic document, wherein spatial relationships between candidate cells can be determined and respective links between respective candidate cells can be created based on the respective relationships between respective candidate cells, in accordance with various aspects and embodiments of the disclosed subject matter.

FIG. 10 presents a block diagram of an example, non-limiting subgroup of candidate cells that can be part of a group of candidate cells that can be associated with a table of data in an electronic document, wherein respective placement of respective candidate cells, including the respective column and row spans of the respective candidate cells, of the table can be determined based at least in part on the information relating to a graph structure associated with the table and a group of rules, in accordance with various aspects and embodiments of the disclosed subject matter.

FIG. 11 depicts a diagram of an example recreated table that can be recreated or extracted from an electronic document, comprising a table, after performing various analyses on information relating to the electronic document, and cell identification, cell relationship identification, and cell placement determinations based on the analyses of the information relating to the electronic document, in accordance with various aspects and embodiments of the disclosed subject matter.

FIG. 12 depicts an example block diagram of an example communication device operable to engage in a system architecture that facilitates wireless communications according to one or more embodiments described herein.

FIG. 13 illustrates a flow diagram of an example, non-limiting method that can desirably process an electronic document comprising a table to desirably extract and/or recreate the table, including the table structure and the information in the table, to generate an editable and searchable electronic textual document comprising the recreated table, in accordance with various aspects and embodiments of the disclosed subject matter.

FIGS. 14 and 15 depict a flow diagram of an example, non-limiting method that can identify a group of candidate cells of a table presented in an electronic document, in accordance with various aspects and embodiments of the disclosed subject matter.

FIG. 16 illustrates a flow diagram of an example, non-limiting method that can determine respective relationships between respective candidate cells of a table presented in an electronic document, in accordance with various aspects and embodiments of the disclosed subject matter.

FIG. 17 depicts a flow diagram of an example, non-limiting method that can determine respective row span and/or placement, and/or respective column span and/or placement, of respective candidate cells of a group of cells of a table presented in an electronic document, in accordance with various aspects and embodiments of the disclosed subject matter.

FIG. 18 illustrates an example block diagram of an example computing environment in which the various embodiments of the embodiments described herein can be implemented.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details (and without applying to any particular network environment or standard).

Discussed herein are various aspects and embodiments that relate to employing a multi-stage process to process electronic documents comprising tables to desirably extract a table from a document and recreate the table, including the table structure and information (e.g., textual information) in the table, in an editable form. The disclosed subject matter can significantly improve the efficiency and accuracy of determining and recreating the structure of the cells of the table and information contained in the cells of the table, as compared to traditional techniques, systems, and methods of processing documents that include tables.

Physical documents can be scanned, photographed, or captured using devices, such as scanners (e.g., stand-alone scanner or printer/scanner), communication devices (e.g., mobile phones), or other devices with scanning or photographic capabilities. Typically, with regard to a scanned, photographed, or captured document, or an electronic document created using certain applications, the text and/or other features (e.g., tables) of such document are not editable or retrievable from or in such document because the text and/or other features, and the background, of the document are part of the same layer.

Detecting and extracting information in or from such types of documents can be problematic using traditional document processing techniques. Whether such documents are historical documents, documents that do not exist in digital format, or documents that otherwise are comprised of only one layer where the information and background are on the same layer of the document, understanding, retrieving, extracting, or editing the contents of such documents when all that may be available is pixel data of the document continues to be problem that traditional document processing techniques are not well suited to handle. Tables, in particular, in such documents, especially those tables with a complex structure, can be particularly difficult or problematic for many traditional document processing techniques to understand and return in a format that can be suitably or properly recognized by a computer. When using traditional document processing techniques on a table in a document, something as simple as an extra cell between columns can throw off calculations and return sub-optimal results when doing analysis on the table contents. The difficulty lies not only in detecting what pixels should belong in what groupings, but also how those grouping can relate to each other. Many traditional document processing techniques use either complex machine learning algorithms to detect structure of tables in documents or rely on converting the document into a portable document format (PDF) document with optical character recognition (OCR) information embedded within it (e.g., use an OCR technology to read the document and return the text). Some problems with these traditional document processing techniques can include low accuracy and high potential for misrepresented sections in the results from converting the document and performing OCR on it. Often, with the traditional machine learning techniques, the accuracy in the results of obtaining or extracting tables from documents can be approximately 70% accuracy at best. With traditional PDF techniques, the accuracy in the results of obtaining or extracting tables from documents may be as high as 90%, but the traditional PDF techniques can be unreliable as there can be significant potential for garbage characters in the PDF format.

The disclosed subject matter can overcome these and other problems associated with processing documents that comprise tables that contain textual information to extract and recreate the tables and associated textual information.

To that end, the disclosed subject matter presents techniques, methods, and systems that can desirably process an electronic document comprising a table to desirably extract and/or recreate the table, including the table structure (e.g., arrangement of the cells of the table) and the information in the table (e.g., respective items of information in the respective cells of the table), to generate an editable and searchable electronic textual document comprising the recreated table. The disclosed subject matter can comprise a document processing management component (DPMC) that can manage and/or perform various processing of documents (e.g., electronic documents) comprising tables to desirably (e.g., efficiently and accurately) extract and/or recreate tables, including table information in the tables, from the documents, wherein the extracted or recreated tables desirably can be in an editable form and can be in a form that can replicate the original structures of the tables. A table can comprise cells (e.g., table entry regions) that can be arranged in rows and columns, wherein the cells each can be the same size or the cells can be differently sized, depending on the table and the information being presented in the table. Some tables can have border lines (e.g., outlines) that can define or delineate the shapes and sizes of the cells, wherein the border lines can surround the information (e.g., textual data) within the cells. Other tables can be structured to have free floating cells that have no border lines (e.g., there can be background space between each cell of the table). Still other tables can comprise cells that can be defined by border lines and other cells that can be free floating cells.

The DPMC can employ a multi-stage (e.g., three stage) process for performing processing of documents that comprise tables. The first stage of the multi-stage process can involve cell candidate selection, wherein the DPMC can analyze pixel information in the document (e.g., image data of the image or document) to detect or identify candidate cells (e.g., actual or at least potential cells) of the table and extract the candidate cells. In accordance with various embodiments, the DPMC can employ desired image analysis techniques to detect candidate cells (e.g., candidate cells that have border lines and/or free floating candidate cells) that can be associated with (e.g., can be part of or at least potentially can be part of) the table. Based at least in part on the analysis results, the DPMC can detect border lines that can be or can indicate borders of candidate cells in the table (e.g., border lines that can form squares or rectangles that can define or indicate candidate cells of the table). A document, which comprises a table, often can comprise other information (e.g., textual information in sentences or paragraphs, or graphical images, such as photographs or drawings).

As part of the analysis, the DPMC also can identify areas of the document that can comprise textual information, which can include textual information that can be part of free floating candidate cells (if the table contains any free floating candidate cells), textual information that is not part of the table, and/or a graphical image. The DPMC can process the textual information to form blocks (e.g., transform the textual information into blocks where the characters of the textual information can be indistinguishable), can group blocks that are determined to be in relatively close proximity to each other (e.g., words of a sentence, sentences of a paragraph), and can place bounding boxes around the groups of blocks (e.g., word, sentence, or paragraph groups) and/or individual blocks that are not part of a group of blocks (e.g., individual blocks that can be free floating candidate cells).

In some embodiments, the DPMC can perform a character recognition analysis on the textual information (e.g., the corresponding image data as it exists prior to processing such image data to create the blocks) associated with the blocks and bounding boxes to identify the respective textual information associated with the respective bounding boxes.

The DPMC can analyze the textual information associated with the bounding boxes and can remove bounding boxes determined from such analysis to be associated with words, sentences, or paragraphs that are determined not to be free floating candidate cells that can be associated with the table to facilitate further analysis of candidate cells. If any free floating candidate cells have been identified in the document, the DPMC can include those free floating candidate cells in the group (e.g., set or list) of candidate cells (e.g., along with the candidate cells that have border lines). The DPMC can sort the candidate cells based at least in part on the probability that a candidate cell is part of the table. In accordance with various embodiments, the DPMC can employ a set of rules or artificial intelligence techniques to sort candidate cells based at least in part on the respective probabilities that the respective candidate cells are part of the table.

During the second stage of the multi-stage process, the DPMC can determine and model the respective relationships between respective candidate cells of the group of candidate cells that can be associated with the table. Based at least in part on the results of analyzing the document, the DPMC can detect, determine, or identify respective spatial relationships between respective candidate cells to create a graph structure that can be representative of the arrangement of the cells (e.g., candidate cells) of the table in the document. The DPMC can analyze each candidate cell with regard to how that candidate cell relates to other candidate cells in the document space. For instance, the DPMC can analyze the regions above, below, left, and right of each candidate cell to determine whether there is another candidate cell that is in line with and/or in proximity to the candidate cell under consideration in any of those regions of the document space. With regard to the candidate cell under consideration, the DPMC can create an association (e.g., a link, connection, or mapping) between the edge of the candidate cell and the edge (e.g., proximate edge) of another candidate cell that is in line (e.g., fully or at least partially in line) with the candidate cell and is in a region that is above, below, left, or right of the candidate cell, so long as the candidate cell is not blocked by a third candidate cell between the candidate cell and the other candidate cell. For example, with regard to a candidate cell under consideration, for any other candidate cell that is determined, by the DPMC, to be to the left of the candidate cell in the document space and is not blocked by a third candidate cell, the DPMC can form an association (e.g., link, connection, or mapping) between the edge (e.g., left edge) of the candidate cell (e.g., the candidate cell edge facing the other candidate cell) and the edge (e.g., right edge) the other candidate cell (e.g., the candidate cell edge facing the candidate cell under consideration). If, based on the analysis of the document, with regard to a candidate cell under consideration, the DPMC determines that there is no candidate cell that are in a given direction (e.g., left, right, above, below), the DPMC can determine that the candidate cell (and table edge) can be associated with (e.g., connected to) the edge of the document and can create a link for that instance. After analyzing each of the candidate cells, and as a result of such determining such respective spatial relationships between respective candidate cells associated with the table, the DPMC can have (e.g., can generate) an interconnected graph of the cell candidates that can be representative of the relationships between the cells of the table in the document, wherein the DPMC can know the proximate or immediate neighbor (e.g., adjacent) candidate cells for each candidate cell and the directional relationship between each candidate cell and its proximate or immediate neighbor candidate cells (e.g., the direction an immediate neighbor candidate cell is in in relation to the candidate cell under consideration).

During the third stage of the multi-stage process, the DPMC can utilize the relational information relating to the relationships (e.g., associations or links) between the candidate cells associated with the table to determine (e.g., derive) column and row placement (e.g., position) of the respective candidate cells in the table (e.g., in the grid structure of the table) and the number of rows and number of columns each candidate cell spans in the table, since some tables can have one or more cells that can span over several rows or columns In some embodiments, the DPMC can employ a set of rules and relational information (e.g., can apply the set of rule to the relational information) to determine the column and row placements of candidate cells and the sizes (e.g. numbers of rows and columns) of candidate cells. For example, in accordance with the set of rules, the DPMC can determine or deem (e.g., assume) that, if a second candidate cell is to right of a first candidate cell, the column number of the second candidate cell in the table is at least one greater than the column number of the first candidate cell in the table. As another example, in accordance with the set of rules, the DPMC can determine or deem that, if a first candidate cell has two connections respectively to a second candidate cell and a third candidate cell on the right side (e.g., right edge) of the first candidate cell, the first candidate cell is at least two rows in height in the table, since the first candidate cell has to have enough space to allow for both of those connections to those other candidate cells. Accordingly, based on the set of rules, the DPMC can determine or deem that any candidate cell(s) (if any) to the left of the first candidate cell has to be able to distribute at least two rows, so, if there is only one connection between the first candidate cell and another candidate cell(s) on the left of the first candidate cell, the DPMC can determine or deem that such other candidate cell(s) also can be at least two rows in height in the table as well. Using this set of rules, the DPMC can determine the row and column location information, and width and height information, for each candidate cell associated with the table. The set of rules also can comprise certain rules that can pertain to how candidate cells are connected to each other and instances where connections between candidate cells can overlap, which potentially can affect placement of candidate cells in the table, as more fully described herein. At completion of the third stage of the disclosed multi-stage process, the DPMC can know the row and column location information, and width and height information (e.g., column span and row span), for each candidate cell associated with the table.

After completion of the multi-stage process, the DPMC can determine and generate one or more different types of informational structures (e.g., table structures or graph structures) that be representative of the table in the document. For instance, based at least in part on the results of performing the multi-stage process, the DPMC can generate a grid layout that can in the form of an electronic spreadsheet that can be representative of the table, including the information in each of the cells of the table and the structure (e.g., arrangement of the cells) of the table, and/or the DPMC can generate a different type (e.g., a relatively more complex type) of graph structure that can be representative of the table, including the information in each of the cells of the table and the structure of the table, as more fully described herein. Each of the various types of informational structures (e.g., table structures or graph structures) can have its own advantages and can be utilized, as desired, in different ways for further analysis of the contents (e.g., data in each of the cells) of the table.

The disclosed subject matter, employing the DPMC, can desirably (e.g., accurately, efficiently, and/or optimally) identify a table in an electronic document, including cells of the table, items of data contained in the cells of the table, and structure and features of the table and cells (e.g., arrangement of the cells, row and column placements of cells, row spans of cells, and column spans of cells), and can recreate or extract the table, including the cells and associated data, in a desirable format, wherein the data in the table can be editable and searchable. Further, the disclosed subject matter, by employing the DPMC and techniques disclosed herein, can more desirably (e.g., accurately, efficiently, and/or optimally) identify, extract, and/or recreate a table, including cells and associated data, of an electronic document, as more fully described herein, as compared to traditional techniques for analyzing documents that contain tables of data.

These and other aspects and embodiments of the disclosed subject matter will now be described with respect to the drawings.

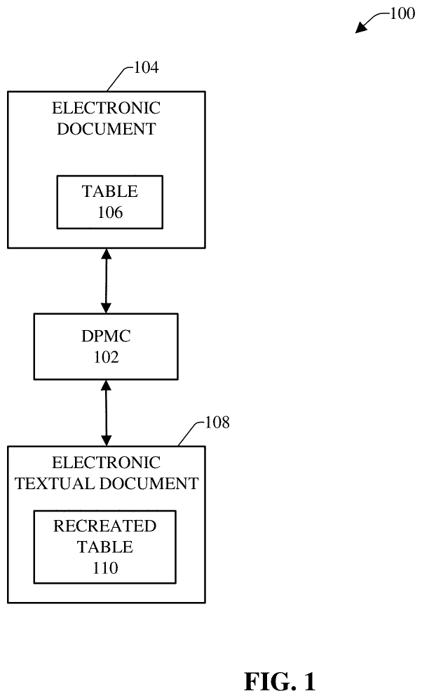

FIG. 1 depicts a block diagram of an example, non-limiting system 100 that can desirably (e.g., accurately and efficiently) process an electronic document comprising a table of data to desirably extract and recreate the table, including the table structure (e.g., arrangement of the cells of the table) and the data in the table (e.g., respective items of information in the respective cells of the table), to generate an editable and searchable electronic textual document comprising the recreated table, in accordance with various aspects and embodiments of the disclosed subject matter. The system 100 can comprise a document processing management component (DPMC) 102 that can process and/or manage processing of electronic documents (e.g., scanned copies, or photographed or captured images, of physical documents, PDF documents, or other types of electronic documents), which comprise tables, to desirably extract and recreate the tables, and/or extract and recreate other information, presented therein. In some embodiments, the DPMC 102 can employ and control respective applications (e.g., open source or closed source applications) to perform document or image processing operations on an electronic document (e.g., image data of an electronic document) to desirably (e.g., accurately and efficiently) extract and recreate the table, and/or extract and recreate other information, presented in the electronic document.

In accordance with various embodiments, the DPMC 102 can receive document images of scanned or photographed, or otherwise electronically generated, documents, such as, for example, electronic document 104 (e.g., a document image), from a communication device (not shown in FIG. 1; as more fully described herein) with scanning, photographic, or document generating functionality (e.g., via a communication network) or a communication device, comprising the DPMC 102, can scan or photograph, otherwise electronically generate, documents to create electronic documents (e.g., electronic document 104). An electronic document (e.g., electronic document 104) can be an image of a single-page document or can be a page of a multi-page document. In some instances, the electronic document 104 can comprise a single document layer on which a table 106, respective items of textual information, and a background of the electronic document 104 can reside, wherein the background can surround the table 106 and the respective items of textual information.

The DPMC 102 can process and/or manage processing of the electronic document 104 to extract information, including the table 106, from the electronic document 104, and recreate the information, including the table 106, of the electronic document 104 to desirably (e.g., accurately, efficiently, and/or optimally) generate an electronic textual document, such as, for example, electronic textual document 108, comprising respective editable and/or searchable textual information, such as, for example, the recreated table 110 (e.g., extracted table), including data entries contained therein, of electronic textual document 108. The recreated table 110 can replicate the original table structure of the table 106 (e.g., replicate the arrangement of the cells of the table 106).

A table (e.g., table 106) can comprise cells that can be arranged in rows and columns, wherein the cells each can be the same size or the cells can be differently sized, depending on the table and the information being presented in the table. Some tables can have border lines (e.g., outlines) that can define or delineate the shapes and sizes of the cells, wherein the border lines can surround the information (e.g., textual data) within the cells. Other tables can be structured to have free floating cells that have no border lines (e.g., there can be background space between each cell of the table). Still other tables can comprise cells that can be defined by border lines and other cells that can be free floating cells.

The DPMC 102 can employ a multi-stage (e.g., three stage) process for performing processing of electronic documents (e.g., electronic document 104) that comprise tables (e.g., table 106). With regard to electronic document 104, during the first stage, the DPMC 102 can identify candidate cells of the table 106 of the electronic document 104, including identifying border lines (if any exist) that can represent cell borders of cells of the table 106, identifying any free floating candidate cells (if any exist in the table 106), and identifying textual information (e.g., data entries) of the candidate cells, based at least in part on the results of an analysis of the electronic document 104. During the second stage, the DPMC 102 can determine structural relationships between respective candidate cells and respective neighbor candidate cells in all directions, based at least in part on applicable rules of a group of rules relating to relationships between cells, and can create and record the respective associations (e.g., links) between those candidate cells. During the third stage, the DPMC 102 can determine row and column placement, and scaling, of the candidate cells based at least in part on the respective associations and applicable rules of the group of rules.

These and other aspects and embodiments of the disclosed subject matter will be described or further described with respect to the other drawings, as well as with respect to FIG. 1.

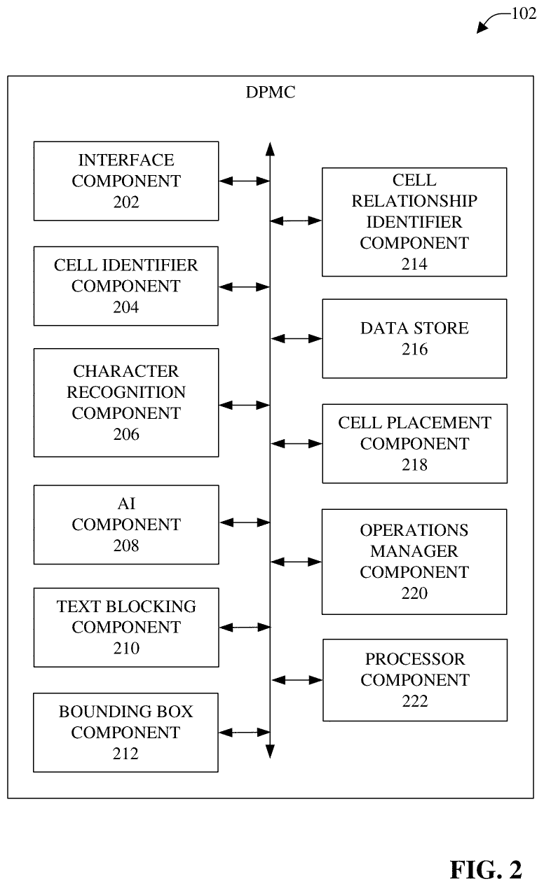

Referring to FIG. 2 (along with FIG. 1), FIG. 2 depicts a block diagram of an example, non-limiting DPMC 102 that can perform and/or manage the multi-stage (e.g., three stage) process for processing of electronic documents (e.g., electronic document 104) that can comprise tables of data (e.g., table 106) to desirably extract and recreate the tables, including the table structure and the data in the tables, to generate an editable and searchable electronic textual documents comprising the recreated tables, in accordance with various aspects and embodiments of the disclosed subject matter. The DPMC 102 can comprise an interface component 202 that can provide interfaces to receive or capture electronic documents (e.g., electronic document 104) or other information or communications and to output electronic textual documents (e.g., electronic textual document 108) or other information or communications. For instance, the interface component 202 can receive an electronic document, which has been captured or generated by a communication device (not shown in FIG. 2; as more fully described herein), from a component of the communication device (e.g., if the component and the DPMC 102 are part of the same communication device) or from the communication device (e.g., directly from the communication device, or via a network device of a communication network, if the DPMC 102 is external to the communication device). The interface component 202 also can present (e.g., communicate or display) an electronic textual document (e.g., electronic textual document 108 comprising recreated table 110) as an output from the DPMC 102, wherein the electronic textual document can be displayed on a display screen (e.g., a display screen interface of or associated with the interface component 202) or communicated to a communication device.

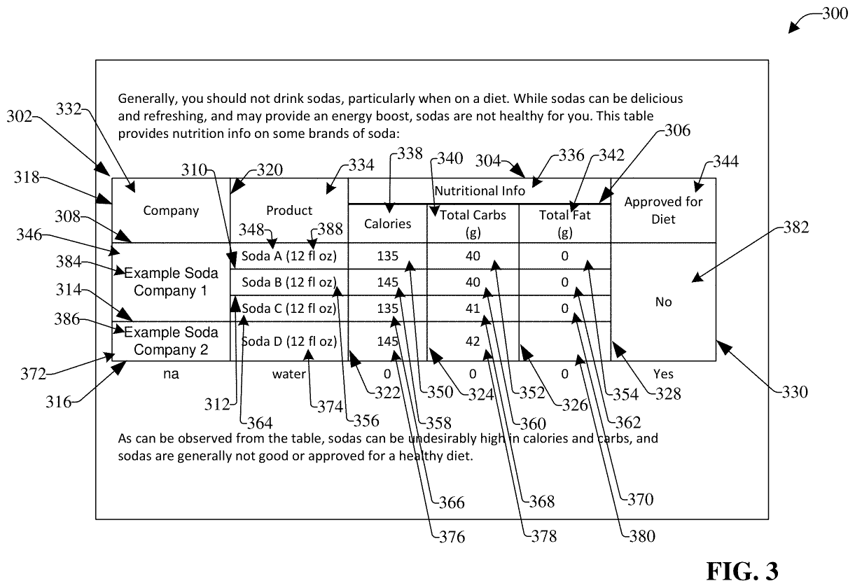

Referring to FIG. 3 (along with FIGS. 1 and 2), FIG. 3 presents a diagram of an example, non-limiting electronic document 300 that can comprise a table 302 that can comprise various items of data, in accordance with various aspects and embodiments of the disclosed subject matter. The DPMC 102 can receive the electronic document 300 (e.g., receive or capture information, such as image data, of or relating to the electronic document 300) via the interface component 202. The electronic document 300 can comprise a single document layer on which the table 302, the respective items of textual information, and a background of the electronic document 300 can reside, wherein the background can surround the table 302 and the respective items of textual information.

In some embodiments, the DPMC 102 can pre-process the electronic document 300 before performing the multi-stage process. For example, if the pixel information of the electronic document 300 is in color, the DPMC 102 can employ and control a grayscaling application that can convert the color pixel information to grayscale, binarized, or black and white pixel information using a desired grayscaling or binarization technique and algorithm, and a desired group of grayscaling or binarization parameters. As another example, if there is undesirable noise in the electronic document 300, the DPMC 102 can employ and control a noise reduction application to have the noise reduction application identify noise in the electronic document 300 (e.g., the grayscaled image) and modify the electronic document 300 to remove such noise from the electronic document 300 based at least in part on a set of noise parameters, including one or more threshold noise values (e.g., threshold noise reduction values), to generate a modified document image of the electronic document 300. As still another example of document pre-processing, if the orientation of the electronic document 300 is determined to be skewed, the DPMC 102 can employ and control an orientation application to have the orientation application determine the amount of skew from a desired defined angle that the electronic document 300 has and can rotate the electronic document 300 to reduce or eliminate the amount of skewing of the electronic document 300, based at least in part on a set of rotation (e.g., orientation) parameters, including one or more threshold rotation (e.g., orientation) values (e.g., threshold skew reduction values), to generate a rotated document image of the electronic document 300 (e.g., a grayscale, noise-reduced, rotated document image), in accordance with (e.g., to satisfy) a defined document processing criterion relating to skew reduction.

With regard to the multi-stage process, the first stage of the multi-stage process can involve cell candidate selection. To perform cell candidate selection, the DPMC 102 can comprise a cell identifier component 204 that can analyze electronic documents, such as electronic document 300, to facilitate detecting or identifying tables, such as table 302, presented in electronic documents, including candidate cells and associated items of data in tables presented in electronic documents, and/or other information presented in electronic documents. For instance, as part of the first stage of the multi-stage process, with regard to electronic document 300, the cell identifier component 204 can analyze pixel information in the electronic document 300 (e.g., image data that can be representative of the image or document) to detect or identify candidate cells (e.g., actual or at least potential cells) of the table 302 and extract the candidate cells from the table 302. Based at least in part on the analysis results of analyzing the pixel information of the electronic document 300, the cell identifier component 204 can detect border lines (if any exist in the table of the electronic document being analyzed) that can be or can indicate borders of candidate cells in the table (e.g., border lines that can form square, rectangular, or other variously shaped regions that can define or indicate candidate cells that can be associated with the table). For instance, with regard to electronic document 300, based at least in part on the analysis results of analyzing the pixel information of the electronic document 300, the cell identifier component 204 can identify border lines (e.g., outlines), such as, for example, border lines 304, 306, 308, 310, 312, 314, 316, 318, 320, 322, 324, 326, 328, and 330, of the table 302 in the electronic document 300, and accordingly, also can identify the rectangular regions of the table 302 that can be formed by the layout and intersecting of the border lines (e.g., border lines 304 through 330) and can recognize that there is information (e.g., items of data) presented in those rectangular regions. The cell identifier component 204 can treat those rectangular regions as candidate cells that can be associated with (e.g., part of or potentially part of) the table 302. For instance, the cell identifier component 204 can assume that, if a defined region (e.g., square, rectangular, or other shaped region) formed by the border lines is outlining or bordering some textual information on the electronic document, the defined region can be a table candidate (e.g., a candidate cell). Accordingly, with regard to the electronic document 300, from the identified border lines (e.g., border lines 304 through 330), the cell identifier component 204 can identify or determine candidate cells 332, 334, 336, 338, 340, 342, 344, 346, 348, 350, 352, 354, 356, 358, 360, 362, 364, 366, 368, 370, 372, 374, 376, 378, 380, and 382, wherein the candidate cells can be or at least potentially can be cells of the table 302.

The DPMC 102 also can comprise or employ a character recognition component 206 that can perform character recognition analysis on the bordered candidate cells (e.g., candidate cells 332 through 382) that can be associated with the table 302 (e.g., can perform character recognition analysis on the image data representative of the bordered candidate cells) to facilitate identifying, determining, or predicting (e.g., inferring) the characters (e.g., respective items of data comprising respective characters) presented in the bordered candidate cells that can be associated with the table 302 (e.g., presented by the image data representative of the candidate cells that can be associated with the table 302). In accordance with various embodiments, the character recognition component 206 can perform OCR analysis or another desired type of character recognition analysis on the image data representative of the bordered candidate cells (e.g., candidate cells 332 through 382) to facilitate identifying, determining, or predicting the characters presented in the bordered candidate cells. In some embodiments, the Tesseract or another desired type of OCR technique or algorithm can be utilized to perform the character recognition analysis. Based at least in part on the results of the character recognition analysis, the character recognition component 206 can determine or identify the respective items of data presented in the respective bordered candidate cells (e.g., candidate cells 332 through 382). For example, based at least in part on the results of the character recognition analysis, the character recognition component 206 can determine or identify item of data “Example Soda Company 1” 384 presented in candidate cell 346 and item of data “Example Soda Company 2” 386 presented in candidate cell 372, as well as determining or identifying the other items of data presented in the other bordered candidate cells (e.g., candidate cells 332 through 344, 348 though 370, and 374 through 382) that can be associated with the table 302.

In some embodiments, to facilitate the character recognition analysis, the character recognition component 206 can comprise, employ, or access one or more character libraries and/or word libraries that the character recognition component 206 can reference during the character recognition analysis to facilitate identifying characters (e.g., alphabetical characters or text strings, numerical characters or text strings, or alphanumeric text strings). A character library can comprise alphabetical and numerical characters in various forms, since the same character can be presented in a variety of forms (e.g., various fonts or stylings). A word library can comprise a desirably large vocabulary of words and variations of words, wherein the word variations can comprise plural versions of words, abbreviations of words, contractions of multiple words, acronyms of phrases, or other desired variations. In certain embodiments, when the disclosed subject matter is being employed with regard to a particular or specialized area or application (e.g., a particular) that can involve a particular or specialized vocabulary, a word library can comprise words and word variations relating to that particular or specialized area or application.

For example, as part of the character recognition analysis of the table 302, if, for some reason, when analyzing “fl oz” 388 in candidate cell 348, the character recognition component 206 had any issues identifying the individual characters of “fl oz” 388 (e.g., issue regarding whether “1” is an “1” or a “1”; issue regarding whether “o” is an “o” or a “0”), the character recognition component 206 can access a word library that can indicate that “fl oz” is an abbreviation for fluid ounces, and the character recognition component 206 can desirably (e.g., accurately) identify “fl oz” 388 based at least in part on the reference to the abbreviation for “fluid ounces” in the word library.

In some embodiments, to facilitate the character recognition analysis, the character recognition component 206 also can perform desired processing (e.g., post-processing) of characters and items of data determined (e.g., at least initially determined or identified) by performing the character recognition analysis, such as performing spell checking or grammar checking of the respective textual information of the respective candidate cells identified in the electronic document. For instance, there may be some spelling and/or grammatical errors in the textual information associated with a candidate cell due in part to translation issues during the character recognition and text extraction process (e.g., the character recognition application incorrectly identifies the letter “e” as the letter “c” in an item of data, or incorrectly identifies the letter “1” as the number “1” in an item of data). The character recognition component 206 can employ and control a spelling and grammar checking function and/or associated spelling and grammar check application to perform or have the spelling and grammar check application perform spell checking and grammar checking on the respective textual information of the respective candidate cells to detect and correct any spelling or grammar errors in the textual information.

In certain embodiments, as part of the character recognition analysis, the DPMC 102 can comprise or employ an artificial intelligence (AI) component 208 that can utilize one or more desired AI, machine learning, and/or neural network techniques, processes, and/or algorithms, and/or AI systems, machine learning systems, and/or neural networks to perform an AI character recognition analysis on image data representative of characters, text strings, or other objects in the electronic document 300 to identify, determine, or predict (e.g., infer) characters and/or text strings in the electronic document 300 (e.g., in the candidate cells that can be associated with the table 302). In some embodiments, the AI component 208 can reference or be trained using character libraries and/or word libraries as training examples, and/or can be trained using other training examples involving characters and text strings. For instance, the AI component 208 can be trained to recognize or identify characters, words, word variations, or other types of text strings based at least in part on the training examples applied to the AI component 208, and the AI component 208 can continue to be trained and refined to enhance its learning of how to recognize or identify, and enhance its accuracy in recognizing or identifying, characters, words, word variations, or other types of text strings.

A document, which comprises a table, often can comprise information that is not bordered by border lines, wherein such information can be or can comprise table cells (e.g., free floating cells) that do not have border lines, textual information in the form of sentences or paragraphs, and/or graphical images, such as graphs, photographs, or drawings. As part of the analysis of the electronic document 300, in addition to identifying bordered candidate cells that can be associated with the table 302 (when bordered cells exist in a table), the cell identifier component 204 also can identify information located in other areas of the document, wherein such information can comprise textual information, which can include textual information that can be part of free floating candidate cells (if the table contains any free floating candidate cells, as table 302 does) and/or textual information that is not part of the table, and/or a graphical image(s).

To facilitate determining whether the electronic document 300 contains any free floating candidate cells, the DPMC 102 can comprise a text blocking component 210 that can process textual information located in the other parts of the electronic document 300 (e.g., parts other than the bordered candidate cells of the table 302) to form blocks (e.g., process or transform the textual information into blocks such that the characters of the textual information can be rendered indistinguishable). For instance, the text blocking component 210 can employ one or more desired image manipulation or filtering techniques and algorithms, and associated parameters, to manipulate or filter the pixel information of the characters to blur, pixelize, or otherwise modify the characters, and spaces between characters or words, to form block-like images such that the characters of the textual information can be rendered indistinguishable or substantially indistinguishable. In some embodiments, prior to the text blocking component 210 processing textual information in the other parts of the electronic document 300 (e.g., image data that can be representative of textual information in the other parts of the electronic document 300), the cell identifier component 204 can remove (e.g., remove or temporarily remove) the bordered candidate cells (e.g., candidate cells 332 through 382) that can be associated with the table 302 from the electronic document 300 (e.g., can remove a portion of the image data that can be representative of the bordered candidate cells of the electronic document 300), to facilitate processing of the other image data associated with the other parts of the electronic document 300 by the text blocking component 210.

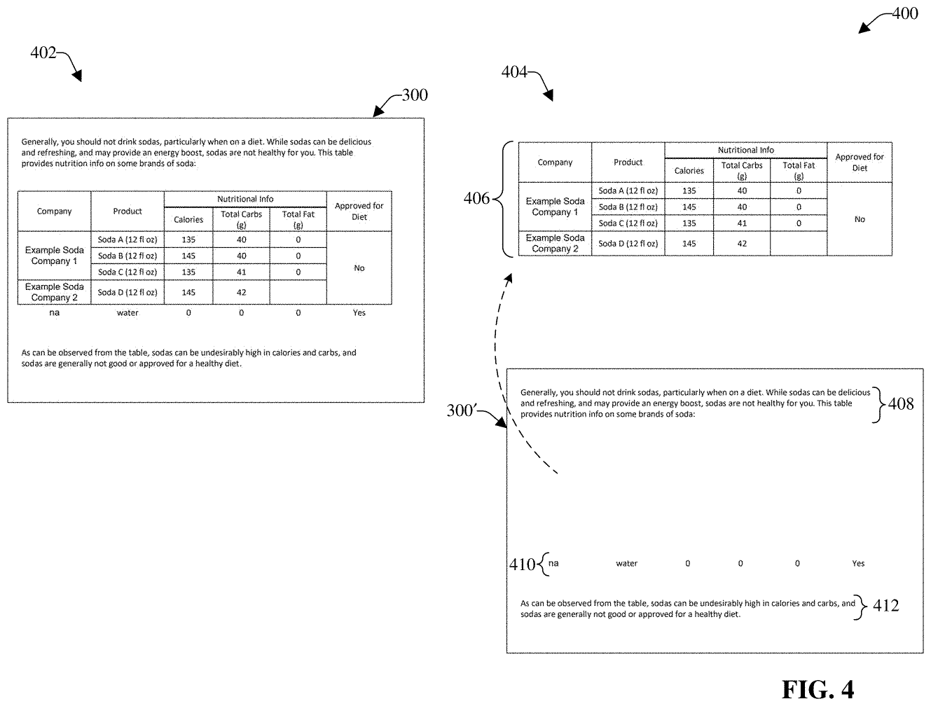

Referring briefly to FIG. 4 (along with FIGS. 1-3), FIG. 4 depicts a diagram of an example, non-limiting image removal process 400 for removal of the bordered candidate cells (e.g., candidate cells 332 through 382) that can be associated with the table 302 from the electronic document 300, in accordance with various aspects and embodiments of the disclosed subject matter. In this example image removal process 400, there can be the electronic document 300 being processed by the DPMC 102, as indicated at reference numeral 402 of the image removal process 400. As indicated at reference numeral 404, after the group of bordered candidate cells 406 (e.g., candidate cells 332 through 382 of FIG. 3) have been identified by the cell identifier component 204, the cell identifier component 204 can remove (e.g., remove or temporarily remove) the group of bordered candidate cells 406 from the electronic document 300, which can leave a remaining portion of the electronic document 300′ for further processing, wherein the remaining portion of the electronic document 300′ can comprise textual information 408 that was above the group of bordered candidate cells 402, textual information 410 that can represent free floating candidate cells that can be identified as such by the cell identifier component 204 (e.g., after further processing and analysis), and textual information 412 near the bottom of the electronic document 300′.

It is to be appreciated and understood that, in certain embodiments, if and as desired, the portion of the image data representative of the group of bordered candidate cells (e.g., candidate cells 332 through 382 of FIG. 3) can remain as part of the electronic document 300 during the processing of the other image data associated with the other parts of the electronic document 300 by the text blocking component 210.

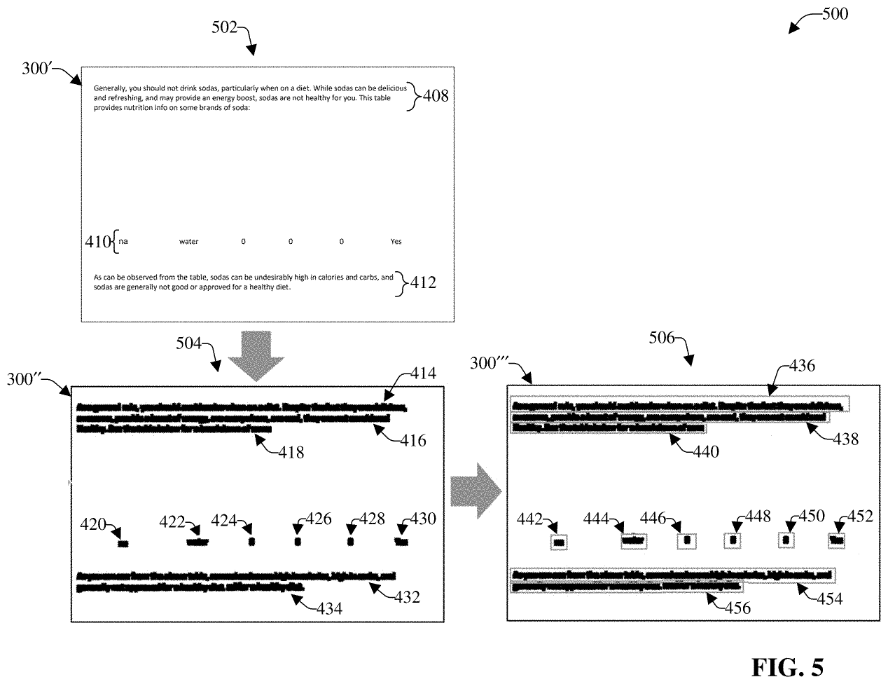

Turning briefly to FIG. 5 (along with FIGS. 1-4), FIG. 5 illustrates a diagram of an example, non-limiting text blocking process 500 that can generate blocks from text in the electronic document 300′, to facilitate identifying free floating candidate cells that can be associated with the table 302, in accordance with various aspects and embodiments of the disclosed subject matter. In some embodiments, as indicated at reference numeral 502 of the example text blocking process 500, the remaining portion of the electronic document 300′ can be ready for further processing by the text blocking component 210.

As indicated at reference numeral 504 of the example text blocking process 500, the text blocking component 210 can process textual information, such as the textual information 408, the textual information 410, and the textual information 412, located in the electronic document 300′ to form respective blocks, as depicted by the group of blocks 414, group of blocks 416, group of blocks 418, block 420, block 422, block 424, block 426, block 428, block 430, group of blocks 432, and group of blocks 434, to generate electronic document 300″ (e.g., generate processed image data of the electronic document based at least in part on the processing of the textual information (e.g., 408, 410, and 412)). For instance, the text blocking component 210 can process or transform the respective image data of the respective textual information 408, 410, and 412 into respective blocks such that the characters of the textual information can be rendered indistinguishable and/or the spaces between adjacent characters, adjacent words, and/or adjacent text strings can be substantially blocked out, as depicted by the group of blocks 414, group of blocks 416, group of blocks 418, block 420, block 422, block 424, block 426, block 428, block 430, group of blocks 432, and group of blocks 434. The groups of blocks 414, 416, and 418 can correspond to (e.g., can be the processed version of) the textual information 408. The blocks 420, block 422, block 424, block 426, block 428, and block 430 can correspond to (e.g., can be the processed version of) the textual information 410. The groups of blocks 432 and 434 can correspond to (e.g., can be the processed version of) the textual information 412.

The cell identifier component 204 can group blocks that are determined by the cell identifier component 204 to be in relatively close proximity to each other (e.g., words of a sentence, or portion thereof, sentences of a paragraph, or portion thereof, that are determined to be within a defined distance of each other). For instance, the cell identifier component 204 can group blocks corresponding to the first line of the textual information 408 together to form the group of blocks 414, can group blocks corresponding to the second line of the textual information 408 together to form the group of blocks 416, and can group blocks corresponding to the third line of the textual information 408 together to form the group of blocks 418, as the groups of blocks 414, 416, and 418 each appear to be or correlate to a sentence or paragraph, or part of a sentence of paragraph (as opposed to appearing to be or correlating to items of data in free floating cells of a table). The cell identifier component 204 also can group blocks corresponding to the first line of the textual information 412 together to form the group of blocks 432, and can group blocks corresponding to the second line of the textual information 412 together to form the group of blocks 434, as the groups of blocks 432 and 434 each appear to be or correlate to a sentence or paragraph, or part of a sentence of paragraph (as opposed to appearing to be or correlating to items of data in free floating cells of the table). The cell identifier component 204 also can identify or determine that block 420, block 422, block 424, block 426, block 428, and block 430 are not in relatively close proximity to each other or in relatively close proximity to the groups of blocks 414, 416, 418, 432, or 434, and accordingly, the cell identifier component 204 can decide that block 420, block 422, block 424, block 426, block 428, and block 430 are not to be grouped together or with another group of blocks.

In certain embodiments, the DPMC 102 can comprise a bounding box component 212 that can work in conjunction with the cell identifier component 204 to facilitate defining groups of blocks (e.g., group of blocks 414, group of blocks 416, group of blocks 418, group of blocks 432, and group of blocks 434) or individual blocks (e.g., block 420, block 422, block 424, block 426, block 428, and block 430) and/or segregating groups of blocks from individual blocks or other groups of blocks and/or individual blocks from groups of blocks or other individual blocks. For instance, as indicated at reference numeral 506 of the example text blocking process 500, the bounding box component 212 can place respective bounding boxes 436, 438, and 440 around group of blocks 414, group of blocks 416, and group of blocks 418; respective bounding boxes 442, 444, 446, 448, 450, and 452 around respective individual blocks, block 420, block 422, block 424, block 426, block 428, and block 430; and respective bounding boxes 454 and 456 around group of blocks 432 and group of blocks 434, wherein this can result in electronic document 300′ being generated.

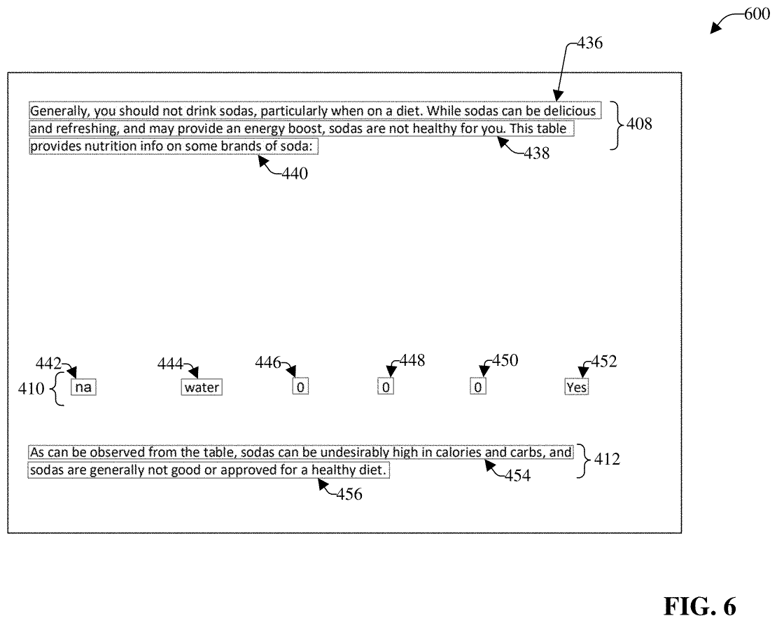

Referring briefly to FIG. 6 (along with FIGS. 1-5), FIG. 6 presents a diagram of an example electronic document 600 that can be generated based at least in part on further processing of the electronic document 300′ presented in FIG. 5 to facilitate identifying the respective textual information associated with the respective bounding boxes, in accordance with various aspects and embodiments of the disclosed subject matter. In some embodiments, if the character recognition component 206 has not already performed character recognition analysis on the textual information 408, textual information 410, and textual information 412 to identify the respective textual information (e.g., characters, text strings) of textual information 408, 410, and 412, the character recognition component 206 can perform character recognition analysis (e.g., Tesseract OCR analysis) on the textual information 408, textual information 410, and textual information 412. For instance, the character recognition component 206 can perform a character recognition analysis on the textual information 408, 410, and 412 (e.g., the corresponding image data as it existed prior to processing to generate blocks in place of the textual information). Based at least in part on the analysis results of such analysis, the character recognition component 206 can determine or identify the respective textual information of the textual information 408, 410, and 412. As depicted in the electronic document 600, respective portions of the identified textual information 408, 410, and 412 can be located in the respective bounding boxes 436, 438, 440, 442, 444, 446, 448, 450, 452, 454, and 456 associated with the respective groups of blocks and individual blocks (e.g., 414 through 434).

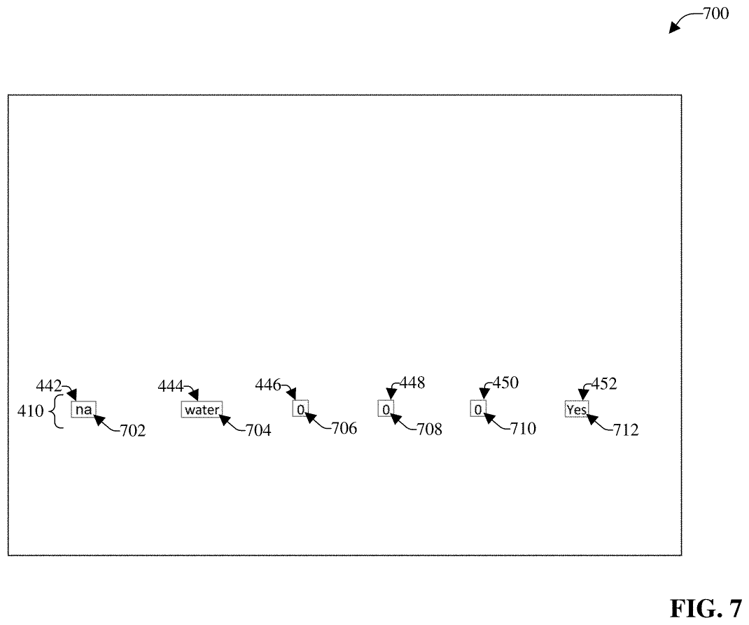

Turning briefly to FIG. 7 (along with FIGS. 1-6), FIG. 7 depicts a diagram of an example electronic document 700 that can be generated as a result of removing bounding boxes of information in the electronic document (e.g., document 600) that are determined to not be part of free floating candidate cells that can be associated with the table 302 to facilitate identifying the free floating candidate cells, in accordance with various aspects and embodiments of the disclosed subject matter. In some embodiments, the cell identifier component 204 can determine bounding boxes of information in the electronic document 600 that are not representative of free floating candidate cells that can be associated with the table 302 based at least in part on the results of analyzing the respective textual information in the respective bounding boxes 436, 438, 440, 442, 444, 446, 448, 450, 452, 454, and 456, as depicted in electronic document 600 of FIG. 6. As a further result of such analysis, the cell identifier component 204 can remove the bounding boxes (e.g., 436, 438, 440, 454, and 456) determined to not be representative of free floating candidate cells that can be associated with the table 302 to generate the electronic document 700 of FIG. 7.

In some embodiments, the cell identifier component 204 can analyze the respective textual information in the respective bounding boxes (e.g., bounding boxes 436 through 456) to determine the number of fill words that often can be found in sentences or paragraphs, but are only found in a cell of a table less frequently (e.g., much less frequently) than in sentences or paragraphs or in relatively small numbers, as compared to sentences or paragraphs. The defined document processing criteria can indicate or specify the words (e.g., “a”, “of”, “the”, “on”, “for”, “are”, or other words that can be considered fill words) or types of words (e.g., determiners, prepositions, conjunctions, or other desired types of words) that can be considered fill words, and the cell identifier component 204 can determine the number of fill words in a bounding box under consideration, in accordance with the defined document processing criteria. In certain embodiments, the cell identifier component 204 can employ one or more rules that can comprise or employ one or more defined threshold number of fill words to facilitate determining whether a bounding box is associated with a free floating candidate cell or is associated with a sentence, paragraph, or other fragment of information (e.g., page header, page footer, page title, page number, addressee, address information, or other information fragment) that is determined to not be a free floating candidate cell. For instance, as part of one rule, the DPMC 102 can set the defined threshold number of fill words to a desired number (e.g., 1, 2, 3, 4, or other desired relatively low number), in accordance with the defined document processing criteria. If, based at least in part on the analysis of the bounding boxes and applying the rule and corresponding threshold number, the cell identifier component 204 determines that a bounding box (e.g., bounding box 436, 438, 440, 454, or 456) contains a number of fill words that satisfies (e.g., breaches; meets or exceeds; is greater than or equal to) the defined threshold number of fill words (e.g., bounding box 436 can be determined to contain at least 5 fill words; bounding box 438 can be determined to contain at least 5 fill words; and bounding box 440 can be determined to contain at least 5 fill words), the cell identifier component 204 can determine that such bounding box is not associated with a free floating candidate cell. If, instead, based at least in part on the analysis of the bounding boxes and applying the rule and corresponding threshold number, the cell identifier component 204 determines that a bounding box (e.g., bounding box 442, 444, 446, 448, 450, and 452) contains a number of fill words that does not satisfy (e.g., does not breach; does not meet or exceed; is less than) the defined threshold number of fill words (e.g., bounding boxes 442, 444, 446, 448, 450, and 452 each can be determined to contain 0 fill words), the cell identifier component 204 can determine that such bounding box can be associated with (e.g., can be representative of) a free floating candidate cell.

In certain embodiments, in addition to, or as an alternative to, that rule and associated defined threshold number, another rule can indicate or specify a defined threshold percentage of fill words relative to a total number of words in a bounding box, wherein such other rule and threshold percentage can be utilized to determine whether the bounding box under consideration is associated with a free floating candidate cell or not. A free floating candidate cell typically can have a relatively lower (e.g., significantly lower) percentage of fill words than a sentence or paragraph, or portion thereof. As an example, if, based at least in part on the analysis of the bounding boxes and applying this other rule and corresponding threshold percentage, the cell identifier component 204 determines that a bounding box satisfies the defined threshold percentage of fill words relative to the total number of words in the bounding box, the cell identifier component 204 can determine such bounding box is not associated with a free floating candidate cell. If, instead, based at least in part on the analysis of the bounding boxes and applying this other rule and corresponding threshold percentage, the cell identifier component 204 determines that a bounding box does not satisfy the defined threshold percentage of fill words relative to the total number of words in the bounding box, the cell identifier component 204 can determine such bounding box can be associated with a free floating candidate cell.

In some embodiments, in addition to, or as an alternative to, the cell identifier component 204 applying the disclosed rule(s) relating to the number or percentage of fill words in a bounding box, the cell identifier component 204 can analyze the respective textual information in the respective bounding boxes (e.g., bounding boxes 436 through 456) to identify punctuation characters (e.g., period, comma, semicolon, quotation marks, or other punctuation characters) that often can be found in sentences or paragraphs, and/or to identify the relationships of a punctuation character(s) to the words in the respective bounding boxes. For example, a period character at the end of a group of words in a bounding box can indicate that the group of words may be a sentence, as opposed to a free floating candidate cell, whereas a period character between two number values can be an indication that the period character may be a decimal point as part of a number being represented in a decimal point format, rather than be a period at the end of a sentence. The defined document processing criteria can indicate or specify the punctuation characters (e.g., period, comma, semicolon, quotation marks, or other punctuation characters) and/or conditions and relationships between punctuation characters and words that can indicate whether the textual information in a bounding box under consideration relates to a free floating candidate cell or instead relates to a sentence, paragraph, or other fragment of information that is not a free floating candidate cell. The cell identifier component 204 can determine the number of punctuation characters in a bounding box under consideration and/or the relationship between punctuation characters and words in the bounding box under consideration, in accordance with the defined document processing criteria. In certain embodiments, the cell identifier component 204 can employ one or more rules that can comprise or employ one or more defined threshold numbers relating to punctuation characters and/or words associated with punctuation characters (e.g., the number of words between two period characters, or the number of words between a comma character and a period character) to facilitate determining whether a bounding box is associated with a free floating candidate cell or is associated with a sentence, paragraph, or other fragment of information (e.g., page header, page footer, page title, page number, addressee, address information, or other information fragment) that is determined to not be a free floating candidate cell.

In still other embodiments, in addition to, or as an alternative to, those two rules and associated threshold values, yet another rule can indicate or specify a defined threshold distance between a bounding box under consideration and a known candidate cell (e.g., a bordered or un-bordered candidate cell that the cell identifier component 204 already has determined is a candidate cell) in the document space of the electronic document (e.g., document 600 with the free floating candidate cells identified and/or with the bordered table cells re-inserted into the document). A cell of a table often can be relatively closer to other cells of the table, wherein a sentence or paragraph of words, or other fragment of information (e.g., page header, page footer, page title, page number, addressee, address information, or other information fragment) often can be a relatively further distance away from cells of a table than the distance between two cells of the table. Accordingly, for example, if, based at least in part on the analysis of the bounding boxes and applying this other rule and corresponding threshold distance, the cell identifier component 204 determines that a bounding box satisfies (e.g., breaches; meets or exceeds; or is greater than or equal to) the defined threshold distance between the bounding box and a cell (e.g., cell that is closest to the bounding box), the cell identifier component 204 can determine such bounding box is not associated with a free floating candidate cell. If, instead, based at least in part on the analysis of the bounding boxes and applying this other rule and corresponding threshold distance, the cell identifier component 204 determines that the bounding box does not satisfy (e.g., does not breach; does not meet or exceed; is less than) the defined threshold distance between the bounding box and the cell, the cell identifier component 204 can determine such bounding box can be associated with a free floating candidate cell. This distance-related rule can facilitate reducing or minimizing the over-inclusion or false identification of candidate cells, such as, for example, certain fragments of information (e.g., page header, page footer, page title, page number, addressee, address information, or other information fragment) that may appear in an electronic document and may not contain a significant amount of fill words, but still are not cells of a table.

In other embodiments, the DPMC 102 can apply one or more other rules and associated threshold values, in addition or, or as an alternative to, the rules aforementioned rules to facilitate determining whether a bounding box of information can be a free floating candidate cell, when so indicated or specified by the defined document processing criteria.

With further regard to the electronic document 600 of FIG. 6, based at least in part on the results of analyzing the bounding boxes 436, 438, 440, 442, 444, 446, 448, 450, 452, 454, and 456, the respective textual information within the respective bounding boxes, and applying the applicable rule or rules, the cell identifier component 204 can determine that bounding boxes 436, 438, 440, 454, and 456 are not associated with free floating candidate cells, and bounding boxes 442, 444, 446, 448, 450, and 452 can be associated with (e.g., representative of) free floating candidate cells. In certain embodiments, the cell identifier component 204 can remove the bounding boxes 436, 438, 440, 454, and 456 and associated textual information from the electronic document 600, and can have bounding boxes 442, 444, 446, 448, 450, and 452 and associated textual information remain in the electronic document to generate electronic document 700, as depicted in FIG. 7. Accordingly, the cell identifier component 204 can identify or determine that the respective textual information (e.g., na, water, 0, 0, 0, and Yes) associated with bounding boxes 442, 444, 446, 448, 450, and 452 can be items of data contained in free floating candidate cells 702, 704, 706, 708, 710, and 712, respectively.

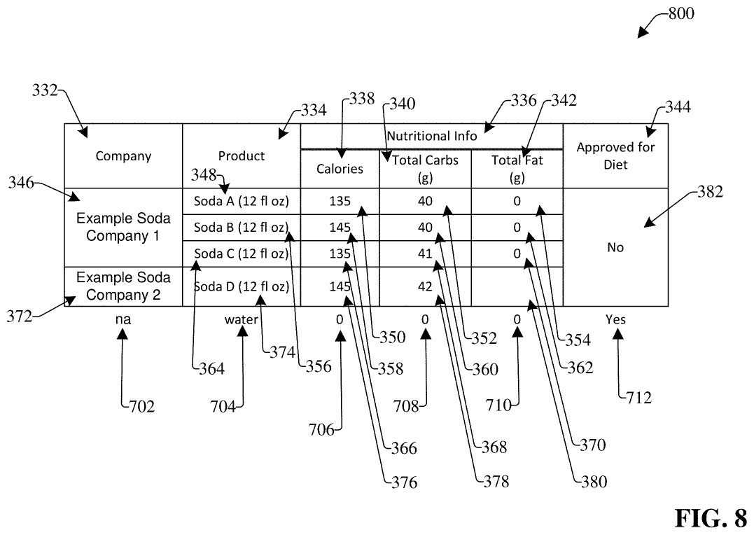

If any free floating candidate cells have been identified in the document (e.g., as is the case with regard to free floating candidate cells 702, 704, 706, 708, 710, and 712), the cell identifier component 204 can include those free floating candidate cells in the group (e.g., set or list) of candidate cells (e.g., along with the candidate cells that have border lines). For instance, with regard to the electronic document (e.g., electronic document 300 of FIG. 3), the cell identifier component 204 can create a group of candidate cells comprising candidate cells 332 through 382 (e.g., bordered candidate cells) and free floating candidate cells 702 through 712. Referring briefly to FIG. 8 (along with FIGS. 1-7), FIG. 8 presents a diagram of an example table 800 that can at least provisionally contain the group of cells, comprising bordered candidate cells 332 through 382 and free floating candidate cells 702 through 712, identified in the electronic document (e.g., document 300) as a result of the analysis performed by the DPMC 102, in accordance with various aspects and embodiments of the disclosed subject matter.

In some embodiments, the cell identifier component 204 can sort (e.g., rank) the candidate cells 332 through 382 and 702 through 712 based at least in part on the probability that a candidate cell is part of the table 302. In accordance with various embodiments, the cell identifier component 204 can employ a set of rules or AI techniques (e.g., employing the AI component 208) to sort candidate cells 332 through 382 and 702 through 712 based at least in part on the respective probabilities that the respective candidate cells are part of the table 302, in accordance with the defined document processing criteria.

During the second stage of the multi-stage process, the DPMC 102 can comprise or employ a cell relationship identifier component 214 that can determine and model the respective relationships between respective candidate cells (e.g., candidate cells 332 through 382 and 702 through 712) of the group of candidate cells that can be associated with the table (e.g., table 302). Based at least in part on the results of analyzing the group of candidate cells (e.g., 332 through 382 and 702 through 712), the cell relationship identifier component 214 can detect, determine, or identify respective spatial relationships between respective candidate cells to create a graph structure that can be representative of the arrangement of the cells (e.g., candidate cells) of the table (e.g., table 302) in the electronic document.

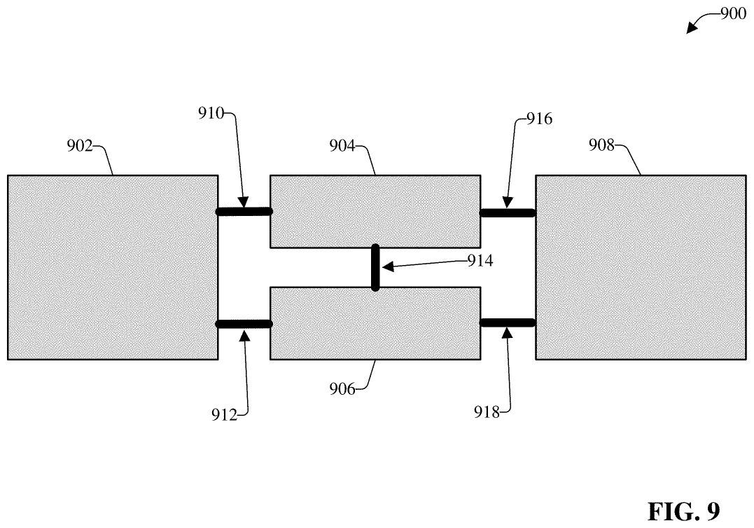

In that regard, referring to FIG. 9 (along with FIGS. 1-3), FIG. 9 illustrates a block diagram of an example, non-limiting subgroup of candidate cells 900 that can be part of a group of candidate cells that can be associated with a table of data in an electronic document, wherein the cell relationship identifier component 214 can determine spatial relationships between candidate cells and can create respective links between respective candidate cells based on the respective relationships between respective candidate cells, in accordance with various aspects and embodiments of the disclosed subject matter. The group of candidate cells, comprising the example subgroup of candidate cells 900, can be candidate cells determined by the cell identifier component 204 using the disclosed analysis and cell identification techniques, as more fully described herein. The example subgroup of candidate cells 900 can comprise candidate cell 902, candidate cell 904, candidate cell 906, and candidate cell 908.

The cell relationship identifier component 214 can analyze the group of candidate cells (e.g., analyze information relating to the group of candidate cells), including the subgroup of candidate cells (e.g., candidate cell 902, candidate cell 904, candidate cell 906, and candidate cell 908). As part of the analysis, the cell relationship identifier component 214 can analyze each candidate cell (e.g., candidate cell 902, candidate cell 904, candidate cell 906, and candidate cell 908) from all directions, including above (e.g., north), below (e.g., south), left (e.g., west), and right (e.g., east) of the candidate cell to determine whether another candidate cell(s) is adjacent and/or in proximity to the candidate cell. Based at least in part on the analysis, the cell relationship identifier component 214 can detect, determine, and/or identify respective spatial relationships between respective candidate cells of the group of candidate cells, including the subgroup of candidate cells (e.g., candidate cell 902, candidate cell 904, candidate cell 906, and candidate cell 908).

For instance, based at least in part on the analysis, with regard to candidate cell 902, the cell relationship identifier component 214 can detect, determine, and/or identify that candidate cell 902 and candidate cell 904 have a relationship (e.g., spatial relationship) to each other because the right edge (e.g., right side) of the candidate cell 902 is adjacent to, and in line with (e.g., horizontally in line with), the left edge (e.g., left side) of the candidate cell 904, where no other candidate cell is in between the right edge of the candidate cell 902 and the left edge of the candidate cell 904 to block the adjacency or relationship between the candidate cell 902 and the candidate cell 904. In response to determining the relationship between the candidate cell 902 and candidate cell 904, the cell relationship identifier component 214 can create a link 910 (e.g., an association or mapping) between the right edge of the candidate cell 902 and the left edge of the candidate cell 904, and can record the link 910 (e.g., can record information relating to the link 910) in a data store 216 of or associated with the DPMC 102. Also, based at least in part on the analysis, the cell relationship identifier component 214 can detect, determine, and/or identify that candidate cell 902 and candidate cell 906 have a relationship to each other because the right edge of the candidate cell 902 is adjacent to, and in line with, the left edge of the candidate cell 906, where no other candidate cell is in between the right edge of the candidate cell 902 and the left edge of the candidate cell 906 to block the adjacency or relationship between the candidate cell 902 and the candidate cell 906. In response to determining the relationship between the candidate cell 902 and candidate cell 906, the cell relationship identifier component 214 can create a link 912 between the right edge of the candidate cell 902 and the left edge of the candidate cell 906, and can record the link 912 (e.g., can record information relating to the link 912) in the data store 216. Further, based at least in part on the analysis, the cell relationship identifier component 214 can determine that there is no direct relationship between candidate cell 902 and candidate cell 908 because there is no space (e.g., gap) of at least one row in size between candidate cell 902 and candidate cell 908, as candidate cell 904 and candidate cell 906 are interposed between candidate cell 902 and candidate cell 906. If, instead, for example, candidate cell 906 was not located in between candidate cell 902 and candidate cell 908, the cell relationship identifier component 214 could have determined that there was a relationship between candidate cell 902 and candidate cell 908, and created a link between candidate cell 902 and candidate cell 908.

Also, based at least in part on the analysis, with regard to candidate cell 904, the cell relationship identifier component 214 can detect, determine, and/or identify that candidate cell 904 also has a relationship to candidate cell 906 because the bottom edge of the candidate cell 904 is adjacent to, and in line with (e.g., vertically in line with), the top edge of the candidate cell 906, where no other candidate cell is in between the bottom edge of the candidate cell 904 and the top edge of the candidate cell 906 to block their adjacency or relationship. In response to determining the relationship between the candidate cell 904 and candidate cell 906, the cell relationship identifier component 214 can create a link 914 between the bottom edge of the candidate cell 904 and the top edge of the candidate cell 906, and can record the link 914 in the data store 216. Further, based at least in part on the analysis, the cell relationship identifier component 214 can detect, determine, and/or identify that candidate cell 904 and candidate cell 908 have a relationship to each other because the right edge of the candidate cell 904 is adjacent to, and in line with, the left edge of the candidate cell 908, where no other candidate cell is in between the right edge of the candidate cell 904 and the left edge of the candidate cell 908 to block their adjacency or relationship. In response to determining such relationship between the candidate cell 904 and candidate cell 908, the cell relationship identifier component 214 can create a link 916 between the right edge of the candidate cell 904 and the left edge of the candidate cell 908, and can record the link 916 in the data store 216. Furthermore, based at least in part on the analysis, with regard to candidate cell 906, the cell relationship identifier component 214 can detect, determine, and/or identify that candidate cell 906 also has a relationship to candidate cell 908 because the right edge of the candidate cell 906 is adjacent to, and in line with, the left edge of the candidate cell 908, where no other candidate cell is in between the right edge of the candidate cell 906 and the left edge of the candidate cell 908 to block their adjacency or relationship. In response to determining the relationship between such candidate cell 906 and candidate cell 908, the cell relationship identifier component 214 can create a link 918 between the right edge of the candidate cell 906 and the left edge of the candidate cell 908, and can record the link 918 in the data store 216.

After determining the respective relationships between the respective cells (e.g., candidate cell 902, candidate cell 904, candidate cell 906, and candidate cell 908) of the entire group of candidate cells that can be associated with the table identified in the electronic document, the DPMC 102 can have a graph structure that can be representative of the arrangement of the candidate cells (e.g., candidate cell 902, candidate cell 904, candidate cell 906, and candidate cell 908) of the table of the electronic document, including the respective relationships between the respective candidate cells and the respective links between respective candidate cells. The cell relationship identifier component 214 can store information relating to the graph structure associated with the table and associated candidate cells in the data store 216.

In some embodiments, in addition to, or as an alternative to, the cell relationship identifier component 214 determining respective relationships and links between respective candidate cells of a group of candidate cells, the DPMC 102 can employ the AI component 208 in conjunction with the cell relationship identifier component 214 to determine respective relationships and links between respective candidate cells of a group of candidate cells for a table, in accordance with the defined document processing criteria. For instance, the AI component 208, in conjunction with the cell relationship identifier component 214, can utilize AI, machine learning, and/or neural network techniques, processes, and/or algorithms to learn about and be trained regarding determining spatial relationships and links between candidate cells of a group of candidate cells that can be associated with a table of an electronic document, and based at least in part on such learning and training, the AI component 208 can apply such learning and training, and utilizing the AI, machine learning, and/or neural network techniques, processes, and/or algorithms, the AI component 208 and cell relationship identifier component 214, working in conjunction with each other, can desirably (e.g., accurately, efficiently, and/or optimally) determine spatial relationships and links between candidate cells of a group of candidate cells that can be associated with a table of an electronic document, in accordance with the defined document processing criteria.

In accordance with various embodiments, the DPMC 102 can comprise or employ a cell placement component 218 that can determine respective placement (e.g., respective spatial placement or position) of the respective candidate cells in the table based at least in part on the information relating to the graph structure associated with the table and associated candidate cells (e.g., as determined by the cell relationship identifier component 214), and a group of rules relating to cell placement, in accordance with the defined document processing criteria. As part of determining the respective placement of the respective candidate cells in the table, the cell placement component 218 also can determine the respective column spans and respective row spans of the respective candidate cells based at least in part on the information relating to the graph structure and the group of rules.

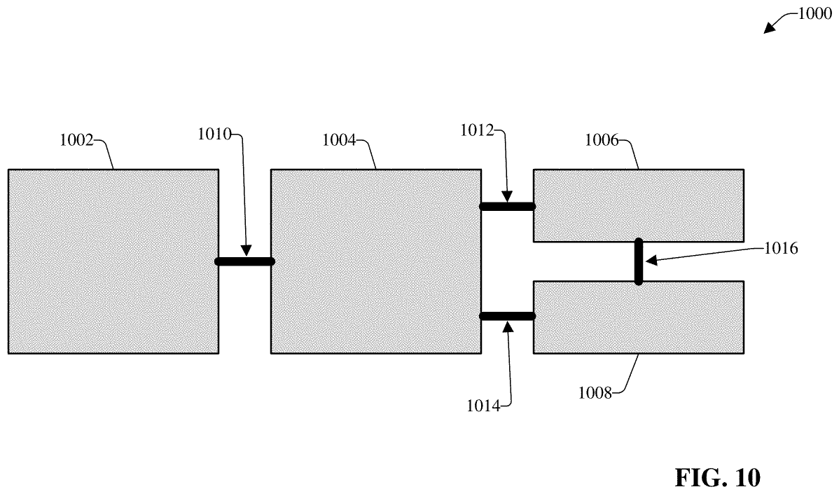

In that regard, turning to FIG. 10 (along with FIG. 1-3), FIG. 10 presents a block diagram of an example, non-limiting subgroup of candidate cells 1000 that can be part of a group of candidate cells that can be associated with a table of data in an electronic document, wherein the cell placement component 218 can determine respective placement of the respective candidate cells, including the respective column and row spans of the respective candidate cells, in the table based at least in part on the information relating to the graph structure associated with the table and the group of rules, in accordance with various aspects and embodiments of the disclosed subject matter. The group of candidate cells, comprising the example subgroup of candidate cells 1000, can be candidate cells identified by the cell identifier component 204 using the disclosed analysis and cell identification techniques, wherein the cell relationship identifier component 214 determined respective spatial relationships between the respective candidate cells, created respective links between respective candidate cells (e.g., between candidate cells that have a spatial relationship to each other), and generated a graph structure that can be representative of the arrangement of the candidate cells of the table of the electronic document, as more fully described herein. The example subgroup of candidate cells 1000 can comprise candidate cell 1002, candidate cell 1004, candidate cell 1006, and candidate cell 1008.

The cell relationship identifier component 214 can analyze the group of candidate cells (e.g., analyze information relating to the group of candidate cells), including the subgroup of candidate cells (e.g., candidate cell 1002, candidate cell 1004, candidate cell 1006, and candidate cell 1008) in a same or similar manner as described herein, for example, with regard to FIG. 9. Based at least in part on the analysis, with regard to candidate cell 1002, the cell relationship identifier component 214 can determine that candidate cell 1002 has a relationship to candidate cell 1004 because the right edge of the candidate cell 1002 is adjacent to, and in line with, the left edge of the candidate cell 1004, where no other candidate cell is in between the right edge of candidate cell 1002 and the left edge of candidate cell 1004 to block their adjacency or relationship. In response to determining the relationship between the candidate cell 1002 and candidate cell 1004, the cell relationship identifier component 214 can create a link 1010 between the right edge of candidate cell 1002 and the left edge of candidate cell 1004, and can record the link 1010 in the data store 216.

Also, based at least in part on the analysis, the cell relationship identifier component 214 can determine that candidate cell 1004 and candidate cell 1006 have a relationship to each other because the right edge of candidate cell 1004 is adjacent to, and in line with, the left edge of the candidate cell 1006, where no other candidate cell is in between the right edge of the candidate cell 1004 and the left edge of the candidate cell 1006 to block their adjacency or relationship. In response to determining such relationship between the candidate cell 1004 and candidate cell 1006, the cell relationship identifier component 214 can create a link 1012 between the right edge of the candidate cell 1004 and the left edge of the candidate cell 1006, and can record the link 1012 in the data store 216.

Further, based at least in part on the analysis, with regard to candidate cell 1004, the cell relationship identifier component 214 can determine that candidate cell 1004 also has a relationship to candidate cell 1008 because the right edge of the candidate cell 1004 is adjacent to, and in line with, the left edge of the candidate cell 1008, where no other candidate cell is in between the right edge of the candidate cell 1004 and the left edge of the candidate cell 1008 to block their adjacency or relationship. In response to determining the relationship between such candidate cell 1004 and candidate cell 1008, the cell relationship identifier component 214 can create a link 1014 between the right edge of the candidate cell 1004 and the left edge of the candidate cell 1008, and can record the link 1014 in the data store 216.

Furthermore, based at least in part on the analysis, with regard to candidate cell 1006, the cell relationship identifier component 214 can determine that candidate cell 1006 also has a relationship to candidate cell 1008 because the bottom edge of the candidate cell 1006 is adjacent to, and in line with, the top edge of the candidate cell 1008, where no other candidate cell is in between the bottom edge of the candidate cell 1006 and the top edge of the candidate cell 1008 to block their adjacency or relationship. In response to determining the relationship between such candidate cell 1006 and candidate cell 1008, the cell relationship identifier component 214 can create a link 1016 between the bottom edge of the candidate cell 1006 and the top edge of the candidate cell 1008, and can record the link 1016 in the data store 216.

In some embodiments, the cell relationship identifier component 214 also can determine edges of candidate cells that do not have relationships with other candidate cells. For example, based at least in part on the analysis, with regard to candidate cell 1002, the cell relationship identifier component 214 can determine that the left edge of the candidate cell 1002 does not have a relationship to another candidate cell, and the top edge of the candidate cell 1002 does not have a relationship to another candidate cell. In certain embodiments, the cell relationship identifier component 214 can determine that the left edge of the candidate cell 1002 has a link to the left edge (e.g., left side) of the electronic document, and the top edge of the candidate cell 1002 has a link to the top edge of the electronic document. The cell relationship identifier component 214 can make similar determinations with regard to each candidate cell of the group of cells that does not have a relationship with other candidate cells on one or more edges of such candidate cell.

The cell relationship identifier component 214 can perform the analysis of the group of candidate cells, determine such respective relationships between respective candidate cells (and/or between candidate cells and the edges of the electronic document), and create respective links between respective candidate cells with regard to all candidate cells of the group of candidate cells, such as described herein. Based at least in part on the respective relationships and respective links between the respective candidate cells of the group of candidate cells (e.g., candidate cell 1002, candidate cell 1004, candidate cell 1006, and candidate cell 1008), the cell relationship identifier component 214 can determine and generate the graph structure of the table, including the group of candidate cells, as more fully described herein.

The cell placement component 218 can analyze information relating to the graph structure of the table, including the group of candidate cells (e.g., candidate cell 1002, candidate cell 1004, candidate cell 1006, and candidate cell 1008). Based at least in part on the results of such analysis and application of the set of rules relating to cell placement, the cell placement component 218 can determine respective placements, including respective column numbers, respective row numbers, respective column spans (e.g., column extents, lengths, or sizes), and respective row spans (e.g., row extents, lengths, or sizes), of the respective candidate cells (e.g., candidate cell 1002, candidate cell 1004, candidate cell 1006, and candidate cell 1008) of the group of candidate cells in the table.

For instance, based at least in part on the results of such analysis, with regard to the candidate cell 1004, the cell placement component 218 can determine that the right edge of candidate cell 1004 has a relationship, and a link 1012, with the left edge of candidate cell 1006, the right edge of candidate cell 1004 also has a relationship, and a link 1014, with the left edge of candidate cell 1008, the left edge of candidate cell 1004 has a relationship, and a link 1010, with the right edge of candidate cell 1002, and the top edge of candidate cell 1004 does not have a relationship or link to another candidate cell (and/or does have a relationship or link to the top edge of the electronic document). A first rule of the group of rules can indicate or specify that the row span of a candidate cell (e.g., candidate cell 1004) can be based at least in part on the number of links (e.g., can be at least equal to, and potentially can be greater than, the number of links) between the right edge of the candidate cell and the left edge(s) of the candidate cell(s) with which the candidate cell has a relationship, or correspondingly, the row span of a candidate cell can be based at least in part on the number of links between the left edge of the candidate cell and the right edge(s) of the candidate cell(s) with which the candidate cell has a relationship. A second rule of the group of rules can indicate or specify that each candidate cell has to be or span at least one row in height and has to be or span at least one column in length. As an example, with regard to candidate cell 1002, the cell placement component 218 can determine that the candidate cell 1004 has two links (e.g., links 1012 and 1014) between its right edge and the left edges of candidate cells 1006 and 1008. Accordingly, based at least in part on application of the first rule and the second rule, the cell placement component 218 can determine that the row span of the candidate cell 1004 is at least two, or at least can determine that the probability can be relatively high that the row span of the candidate cell 1004 in the table is at least two (e.g., in the table, the candidate cell 1004 can span at least two rows) because candidate cell 1006 and candidate cell 1008 each have to span at least one row and the right edge of candidate cell 1004 has two links that respectively link to the left edges of candidate cell 1006 and candidate cell 1008.

Also, according to a third rule of the group of rules, a candidate cell with a right edge (or left edge) that is linked to a left edge (or right edge) of another candidate cell has to have a row span that is at least as tall in height as the row span of the other candidate cell, and similarly, a candidate cell with a bottom edge (or top edge) that is linked to a top edge (or bottom edge) of another candidate cell has to have a column span that is at least as long in length as the column span of the other candidate cell. With regard to candidate cells 1002 and 1004, based at least in part on application of the third rule, the cell placement component 218 can determine that the row span of candidate cell 1002 also can be at least two rows, or at least can determine that the probability can be relatively high that the row span of the candidate cell 1002 in the table is at least two, because the row span of the candidate cell 1002 has been determined to be at least two and there is a link between the right edge of candidate cell 1002 and the left edge of candidate cell 1004.

A fourth rule of the group of rules can indicate or specify that, if a top edge of a candidate cell does not have a relationship to another candidate cell (and/or, accordingly, has a relationship and/or link to the top edge of the electronic document), the candidate cell can be in a first row of the table (e.g., the probability can be relatively high that the candidate cell can be in the first row of the table), and similarly, if a bottom edge of a candidate cell does not have a relationship to another candidate cell (and/or, accordingly, has a relationship and/or link to the bottom edge of the electronic document), the candidate cell can be in a last row of the table. Accordingly, with regard to candidate cell 1002, candidate cell 1004, and candidate cell 1006, based at least in part on application of the fourth rule, the cell placement component 218 can determine that, since the top edges of candidate cell 1002, candidate cell 1004, and candidate cell 1006 do not have a relationship with another candidate cell (and/or, accordingly, do have a relationship and/or link to the top edge of the electronic document), the candidate cell 1002, candidate cell 1004, and candidate cell 1006 can be in, or at least the probability can be relatively high that the candidate cell 1002, candidate cell 1004, and candidate cell 1006 can be in, the first row of the table.

A fifth rule of the group of rules can indicate or specify that, if a left edge of a candidate cell does not have a relationship to another candidate cell (and/or, accordingly, has a relationship and/or link to the left edge of the electronic document), the candidate cell can be in a first column of the table (e.g., the probability can be relatively high that the candidate cell can be in the first column of the table), and similarly, if a right edge of a candidate cell does not have a relationship to another candidate cell (and/or, accordingly, has a relationship and/or link to the right edge of the electronic document), the candidate cell can be in a last column of the table. Accordingly, with regard to candidate cell 1002, based at least in part on application of the fifth rule, the cell placement component 218 can determine that, since the left edge of the candidate cell 1002 does not have a relationship with another candidate cell (and/or, accordingly, does have a relationship and/or link to the left edge of the electronic document), the candidate cell 1002 can be in, or at least the probability can be relative high that the candidate cell 1002 can be in, the first column of the table.

A sixth rule of the group of rules can indicate or specify that, if a left edge of a candidate cell has a relationship to (e.g., is linked to) a right edge of another candidate cell, the other candidate cell can be in a column of the table that is at least one greater in number than the column number of the candidate cell, which is to the left of the other candidate cell, and similarly, if a bottom edge of a candidate cell has a relationship to (e.g., is linked to) a top edge of another candidate cell, the other candidate cell can be in a row of the table that is at least one greater in number than the row number of the candidate cell. Accordingly, with regard to candidate cell 1004 in relation to candidate cell 1002, based at least in part on application of the sixth rule, the cell placement component 218 can determine that, since the left edge of the candidate cell 1002 has a link 1010 to the right edge of candidate cell 1004, the candidate cell 1004 can be in, or at least the probability can be relative high that the candidate cell 1004 can be in, at least the second column of the table, since candidate cell 1002 has been determined to be in the first column of the table, and since candidate cell 1002 has to span at least one column in length based on the second rule. Also, with regard to candidate cell 1006 in relation to candidate cell 1008, based at least in part on application of the sixth rule, the cell placement component 218 can determine that, since the bottom edge of the candidate cell 1006 has a link 1016 to the top edge of candidate cell 1008, the candidate cell 1008 can be in, or at least the probability can be relative high that the candidate cell 1008 can be in, at least the second row of the table, since candidate cell 1006 has been determined to be in the first row of the table, and since candidate cell 1006 has to span at least one row in height based on the second rule.

The cell placement component 218 can perform analysis and application of the group of rules to all of the candidate cells (e.g., candidate cell 1002, candidate cell 1004, candidate cell 1006, and candidate cell 1008) of the group of candidate cells to determine the respective cell placement (e.g., column number and row number), respective column span, and respective row span of the respective candidate cells such that the cell placement component 218 can determine and know the respective placements, including respective column numbers, respective row numbers, respective column spans, and respective row spans, of the respective candidate cells in the recreated (e.g., extracted and/or rasterized) table. With regard to the subgroup of candidate cells 1000, after the cell placement component 218 has performed analysis and application of the group of rules to all of the candidate cells, the cell placement component 218 can determine that the candidate cell 1002 is located in the first row and first column of the table, has a column span of one, and has a row span of two; the candidate cell 1004 is located in the first row and second column of the table, has a column span of one, and has a row span of two; the candidate cell 1006 is located in the first row and third column of the table, has a column span of one, and has a row span of one; and the candidate cell 1008 is located in the second row and third column of the table, has a column span of one, and has a row span of one. The cell placement component 218 can store information relating to the cell placement of the respective candidate cells of the group of candidate cells in the data store 216.

It is to be appreciated and understood that, while certain rules of the group of rules relating to cell placement have been described herein, those certain rules are non-limiting examples of the rules relating to cell placement that the cell placement component 218 can utilize to facilitate determining cell placement (e.g., column number, row number, column span, and row span) of candidate cells for a table, and the disclosed subject matter can employ one or more other desired rules relating to cell placement, in accordance with the defined document processing criteria and disclosed subject matter.

In some embodiments, in addition to, or as an alternative to, the cell placement component 218 utilizing the group of rules relating to cell placement, the DPMC 102 can employ the AI component 208 in conjunction with the cell placement component 218 to determine cell placement of candidate cells of the group of candidate cells in a table of an electronic document. The AI component 208, in conjunction with the cell placement component 218, can utilize AI, machine learning, and/or neural network techniques, processes, and/or algorithms to learn about and be trained regarding cell placement (e.g., column number, row number, column span, and row span) of candidate cells in a table of an electronic document, and based at least in part on such learning and training, the AI component 208 can apply such learning and training, and utilizing the AI, machine learning, and/or neural network techniques, processes, and/or algorithms, the AI component 208 and cell placement component 218, working in conjunction with each other, can desirably (e.g., accurately, efficiently, and/or optimally) determine cell placement (e.g., column number, row number, column span, and row span) of candidate cells in a table of an electronic document, in accordance with the defined document processing criteria.

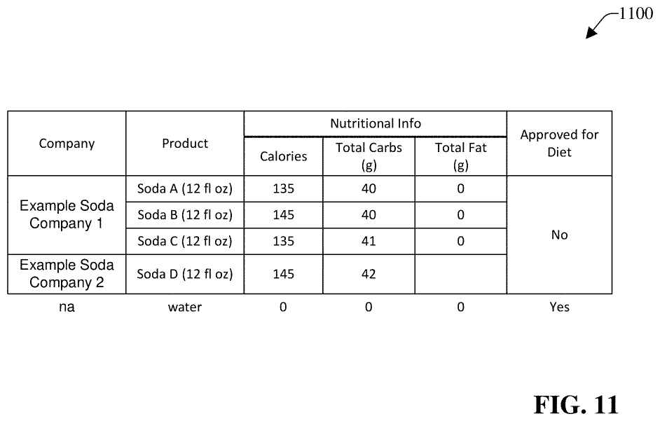

Referring briefly to FIG. 11 (along with FIGS. 1-10), FIG. 11 depicts a diagram of an example recreated table 1100 that can be recreated or extracted from the electronic document 300, comprising table 302, after performing the various analyses on information relating to the electronic document 300, and cell identification, cell relationship identification, and cell placement determinations based on the analyses of the information relating to the electronic document 300, in accordance with various aspects and embodiments of the disclosed subject matter. When compared with the original table 302 of the electronic document 300 of FIG. 3, the recreated table 1100 (e.g., extracted table) of FIG. 11 can desirably (e.g., accurately, efficiently, and/or optimally) recreate and/or maintain the structure and data of the table 302, including the identification of cells of the table 302, the respective placements of respective cells of the table 302, the respective sizes and shapes (e.g., respective column spans, respective row spans) of the respective cells of the table 302, the respective items of data of the respective cells of the table 302, and/or other features of the table 302.

In some embodiments, the DPMC 102 (e.g., employing the interface component 202) can generate and/or present (e.g., display or communicate) the recreated table 1100 in a spreadsheet in a format of a desired spreadsheet application (e.g., EXCEL application). For instance, the DPMC 102 can map the respective relationships between the respective cells (e.g., candidate cells) onto a grid structure, such as a grid structure of a spreadsheet in the format of the desired spreadsheet application, to facilitate recreating the table 302 as the recreated table 1100. In other embodiments, the DPMC 102 (e.g., employing the interface component 202) can generate and/or present (e.g., display or communicate) the recreated table 1100 in another desired format of another desired type of application (e.g., word processing application). The recreated table 1100 can be in an editable and/or searchable format, wherein the respective items of data in the respective cells (e.g., candidate cells) of the recreated table can be edited, as desired, or can be searched (e.g., using a search engine that can search textual characters, words, or strings) to identify items of data that can or may be responsive to a search query for information.

It is to be appreciated and understood that, while the recreated table 1100 is shown by itself without the other information that was located outside of the table 302 of the electronic document 300, as desired, the DPMC 102 also can recreate (e.g., reproduce) the other textual information (e.g., textual information 408 and textual information 412 of FIG. 4) that was located outside of the table 302 of the electronic document 300, and can include that other recreated textual information along with the recreated table 1100 in a recreated electronic document that visually can be same as or desirably similar to the electronic document 300, but also can be in an editable and/or searchable form.

With further regard to FIGS. 1 and 2, in some embodiments, the DPMC 102 can comprise an operations manager component 220 that can control (e.g., manage) operations associated with the DPMC 102. For example, the operations manager component 220 can facilitate generating instructions to have components (e.g., interface component 202, cell identifier component 204, character recognition component 206, AI component 208, text blocking component 210, bounding box component 212, cell relationship identifier component 214, data store 216, cell placement component 218, and/or processor component 222) of or associated with the DPMC 102 perform operations, and can communicate respective instructions to such respective components of or associated with the DPMC 102 to facilitate performance of operations by the respective components of or associated with the DPMC 102 based at least in part on the instructions, in accordance with the defined document processing criteria and the defined document processing algorithm(s) (e.g., document processing algorithms, cell identification algorithms, cell relationship algorithms, cell placement algorithms, and/or AI, machine learning, or neural network algorithms, as disclosed, defined, recited, or indicated herein by the methods, systems, and techniques described herein). The operations manager component 220 also can facilitate controlling data flow between the respective components of the DPMC 102 and controlling data flow between the DPMC 102 and another component(s) or device(s) (e.g., devices or components, such as a communication device, a network device, or other component or device) associated with (e.g., connected to) the DPMC 102.

The DPMC 102 also can comprise a processor component 222 that can work in conjunction with the other components (e.g., interface component 202, cell identifier component 204, character recognition component 206, AI component 208, text blocking component 210, bounding box component 212, cell relationship identifier component 214, data store 216, and/or cell placement component 218) to facilitate performing the various functions of the DPMC 102. The processor component 222 can employ one or more processors, microprocessors, or controllers that can process data, such as information relating to physical documents, document images or electronic documents of physical documents, tables, electronic textual documents, cell identification, character recognition, cell relationship identification, cell placement determinations, rules relating to table extraction or recreation, applications, parameters, metadata, codes, textual strings, communication devices, policies and rules, users, services, defined document processing criteria, traffic flows, signaling, algorithms (e.g., document processing algorithms, cell identification algorithms, cell relationship algorithms, cell placement algorithms, and/or AI, machine learning, or neural network algorithms), protocols, interfaces, tools, and/or other information, to facilitate operation of the DPMC 102, as more fully disclosed herein, and control data flow between the DPMC 102 and other components (e.g., network components of or associated with the communication network, communication devices, or document processing components) and/or associated applications associated with the DPMC 102.

With further regard to the data store 216, the data store 216 can store data structures (e.g., user data, metadata), code structure(s) (e.g., modules, objects, hashes, classes, procedures) or instructions, information relating to physical documents, document images or electronic documents of physical documents, tables, electronic textual documents, cell identification, character recognition, cell relationship identification, cell placement determinations, rules relating to table extraction or recreation, applications, parameters, metadata, codes, textual strings, communication devices, policies and rules, users, services, defined document processing criteria, traffic flows, signaling, algorithms (e.g., document processing algorithms, cell identification algorithms, cell relationship algorithms, cell placement algorithms, and/or AI, machine learning, or neural network algorithms), protocols, interfaces, tools, and/or other information, to facilitate controlling operations associated with the DPMC 102. In an aspect, the processor component 222 can be functionally coupled (e.g., through a memory bus) to the data store 216 in order to store and retrieve information desired to operate and/or confer functionality, at least in part, to the DPMC 102 and its components, and the data store 216, and/or substantially any other operational aspects of the DPMC 102.

It should be appreciated that the data store 216 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

In accordance with various embodiments, the disclosed subject matter, employing the DPMC 102 and its constituent or associated components, and/or associated applications, can perform multiple (e.g., two or more) operations relating to electronic document analysis, cell identification, character recognition, cell relationship identification, cell placement determinations, and/or table recreation with regard to one or more electronic documents in parallel, concurrently, and/or simultaneously, as desired.

In accordance with various embodiments, one or more components (e.g., character recognition component 206, AI component 208, data store 216, processor component 222, or other component) can or may be separate from, and associated with (e.g., communicatively connected to), the DPMC 102, rather than being located within a single device that houses the DPMC 102, wherein the one or more components can be located in remote locations with respect to the DPMC 102. In such various embodiments, the DPMC 102 can access, utilize, and manage (e.g., control) operation of the one or more components via a communication network and/or using a communication device, wherein the communication device and/or DPMC 102 can be associated with (e.g., communicatively connected to) the communication network via a wireless or wireline communication connection. A communication device also can be referred to as, for example, a device, a mobile device, or a mobile communication device. The term “communication device” can be interchangeable with (or include) a UE or other terminology. A communication device (or UE or device) can refer to any type of wireless device that can communicate with a radio network node in a cellular or mobile communication system of a communication network, or can refer to any device that can be connected to a communication network via a wireline communication connection. Examples of communication devices can include, but are not limited to, a cellular and/or smart phone, a mobile terminal, a scanner or multi-purpose printer/scanner device, a computer (e.g., a laptop embedded equipment (LEE), a laptop mounted equipment (LME), or other type of computer), a device to device (D2D) UE, a machine type UE or a UE capable of machine to machine (M2M) communication, a Personal Digital Assistant (PDA), a tablet or pad (e.g., an electronic tablet or pad), a smart meter (e.g., a smart utility meter), an electronic gaming device, electronic eyeglasses, headwear, or bodywear (e.g., electronic eyeglasses, headwear, or bodywear having wireless communication functionality), an appliance (e.g., a toaster, a coffee maker, a refrigerator, or an oven having wireless communication functionality), a device associated or integrated with a vehicle (e.g., automobile, airplane, bus, train, or ship), a drone having wireless communication functionality, a home or building automation device (e.g., security device, climate control device, lighting control device), an industrial or manufacturing related device, and/or any other type of communication devices (e.g., other types of Internet of Things (IoTs)).

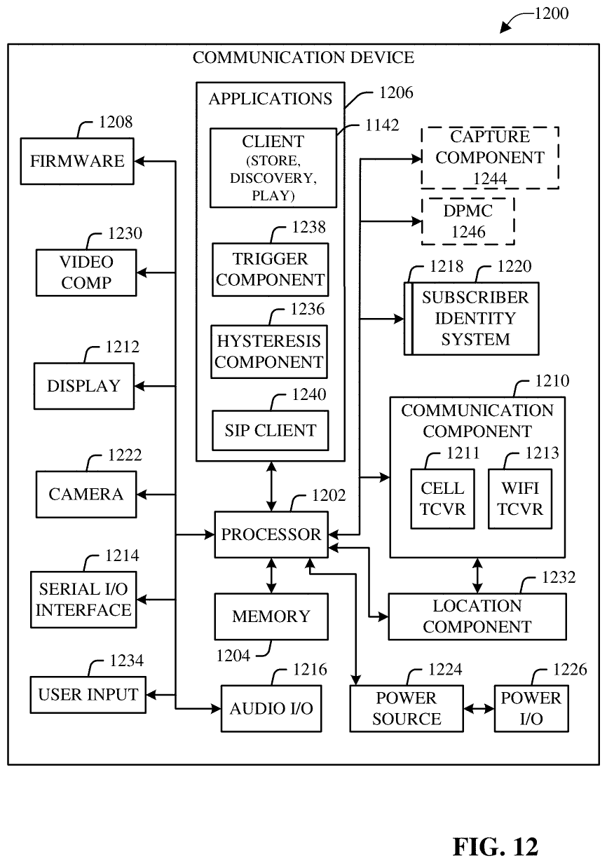

Referring now to FIG. 12, depicted is an example block diagram of an example communication device 1200 (e.g., wireless or mobile phone, electronic pad or tablet, or IoT device) operable to engage in a system architecture that facilitates wireless communications according to one or more embodiments described herein. Although a communication device is illustrated herein, it will be understood that other devices can be a communication device, and that the communication device is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software. Also, while, in some embodiments, the communication device 1200 can be a wireless communication device, in other embodiments of the disclosed subject matter, a communication device can communicate via a wireline communication connection.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The communication device 1200 can include a processor 1202 for controlling and processing all onboard operations and functions. A memory 1204 interfaces to the processor 1202 for storage of data and one or more applications 1206 (e.g., a video player software, user feedback component software, or other application). Other applications can include voice recognition of predetermined voice commands that facilitate initiation of the user feedback signals. The applications 1206 can be stored in the memory 1204 and/or in a firmware 1208, and executed by the processor 1202 from either or both the memory 1204 or/and the firmware 1208. The firmware 1208 can also store startup code for execution in initializing the communication device 1200. A communication component 1210 interfaces to the processor 1202 to facilitate wired/wireless communication with external systems, e.g., cellular networks, VoIP networks, and so on. Here, the communication component 1210 can also include a suitable cellular transceiver 1211 (e.g., a GSM transceiver) and/or an unlicensed transceiver 1213 (e.g., Wi-Fi, WiMax) for corresponding signal communications. The communication device 1200 can be a device such as a cellular telephone, a PDA with mobile communications capabilities, and messaging-centric devices. The communication component 1210 also facilitates communications reception from terrestrial radio networks (e.g., broadcast), digital satellite radio networks, and Internet-based radio services networks.

The communication device 1200 includes a display 1212 for displaying text, images, video, telephony functions (e.g., a Caller ID function), setup functions, and for user input. For example, the display 1212 can also be referred to as a “screen” that can accommodate the presentation of multimedia content (e.g., music metadata, messages, wallpaper, graphics, etc.). The display 1212 can also display videos and can facilitate the generation, editing and sharing of video quotes. A serial I/O interface 1214 is provided in communication with the processor 1202 to facilitate wired and/or wireless serial communications (e.g., USB, and/or IEEE 1394) through a hardwire connection, and other serial input devices (e.g., a keyboard, keypad, and mouse). This supports updating and troubleshooting the communication device 1200, for example. Audio capabilities are provided with an audio I/O component 1216, which can include a speaker for the output of audio signals related to, for example, indication that the user pressed the proper key or key combination to initiate the user feedback signal. The audio I/O component 1216 also facilitates the input of audio signals through a microphone to record data and/or telephony voice data, and for inputting voice signals for telephone conversations.

The communication device 1200 can include a slot interface 1218 for accommodating a SIC (Subscriber Identity Component) in the form factor of a card Subscriber Identity Module (SIM) or universal SIM 1220, and interfacing the SIM card 1220 with the processor 1202. However, it is to be appreciated that the SIM card 1220 can be manufactured into the communication device 1200, and updated by downloading data and software.

The communication device 1200 can process IP data traffic through the communication component 1210 to accommodate IP traffic from an IP network such as, for example, the Internet, a corporate intranet, a home network, a person area network, etc., through an ISP or broadband cable provider. Thus, VoIP traffic can be utilized by the communication device 1200 and IP-based multimedia content can be received in either an encoded or a decoded format.

A video processing component 1222 (e.g., a camera) can be provided for decoding encoded multimedia content. The video processing component 1222 can aid in facilitating the generation, editing, and sharing of video quotes. The communication device 1200 also includes a power source 1224 in the form of batteries and/or an AC power subsystem, which power source 1224 can interface to an external power system or charging equipment (not shown) by a power I/O component 1226.

The communication device 1200 can also include a video component 1230 for processing video content received and, for recording and transmitting video content. For example, the video component 1230 can facilitate the generation, editing and sharing of video quotes. A location tracking component 1232 facilitates geographically locating the communication device 1200. As described hereinabove, this can occur when the user initiates the feedback signal automatically or manually. A user input component 1234 facilitates the user initiating the quality feedback signal. The user input component 1234 can also facilitate the generation, editing and sharing of video quotes. The user input component 1234 can include such conventional input device technologies such as a keypad, keyboard, mouse, stylus pen, and/or touch screen, for example.

Referring again to the applications 1206, a hysteresis component 1236 facilitates the analysis and processing of hysteresis data, which is utilized to determine when to associate with the access point. A software trigger component 1238 can be provided that facilitates triggering of the hysteresis component 1236 when the Wi-Fi transceiver 1213 detects the beacon of the access point. A SIP client 1240 enables the communication device 1200 to support SIP protocols and register the subscriber with the SIP registrar server. The applications 1206 can also include a client 1242 that provides at least the capability of discovery, play and store of multimedia content, for example, music.

The communication device 1200, as indicated above related to the communication component 1210, includes an indoor network radio transceiver 1213 (e.g., Wi-Fi transceiver). This function supports the indoor radio link, such as IEEE 802.11, for the dual-mode GSM device (e.g., communication device 1200). The communication device 1200 can accommodate at least satellite radio services through a device (e.g., handset device) that can combine wireless voice and digital radio chipsets into a single device (e.g., single handheld device).

In some embodiments, the communication device 1200 optionally can comprise a capture component 1244 that can comprise or employ a camera or scanner to capture or scan physical documents or images, including physical documents or images that can comprise tables, which can include cells that contain items of data, as more fully described herein. For example, the capture component 1244 can capture (e.g., capture an image of) a physical document comprising a table that contains a group of cells that comprise items of data, as more fully described herein.

In certain embodiments, the communication device 1200 optionally can comprise a DPMC 1246 that can perform various operations relating to analyzing physical documents or electronic documents, comprising tables, and extracting and/or recreating the tables, including the cells and structure of the tables, in accordance with the defined document processing criteria, as more fully described herein.

The systems and/or devices have been (or will be) described herein with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

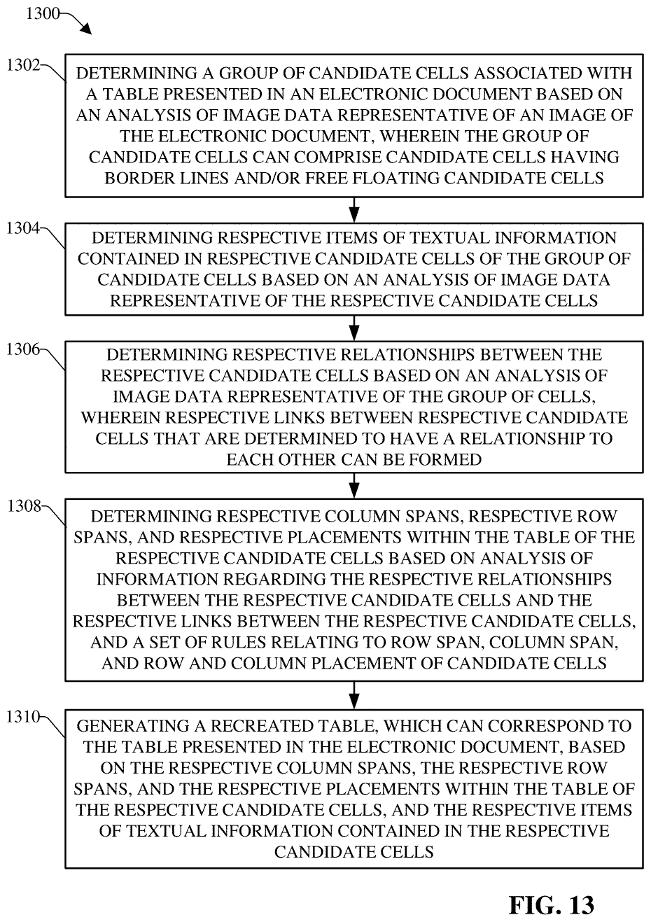

In view of the example systems and/or devices described herein, example methods that can be implemented in accordance with the disclosed subject matter can be further appreciated with reference to flowchart in FIGS. 13-17. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 13 illustrates a flow diagram of an example, non-limiting method 1300 that can desirably (e.g., accurately and efficiently) process an electronic document comprising a table to desirably extract and/or recreate the table, including the table structure (e.g., arrangement of the cells of the table) and the information in the table (e.g., respective items of information in the respective cells of the table), to generate an editable and searchable electronic textual document comprising the recreated table, in accordance with various aspects and embodiments of the disclosed subject matter. The method 1300 can be implemented by a system that can comprise a DPMC, a processor component, a data store, and/or another component(s). Alternatively, or additionally, a machine-readable medium can comprise executable instructions that, when executed by a processor, facilitate performance of the operations of the method 1300.

At 1302, a group of candidate cells associated with a table presented in an electronic document can be determined based at least in part on an analysis of image data representative of an image of the electronic document, wherein the group of candidate cells can comprise candidate cells having border lines and/or free floating candidate cells. The DPMC can analyze image data representative of the image of the electronic document. Based at least in part on the results of analyzing the image data, the DPMC can determine or identify the group of candidate cells, all or some of which can be part of the table presented in the electronic document.

At 1304, respective items of textual information contained in respective candidate cells of the group of candidate cells can be determined based at least in part on an analysis of image data representative of the respective candidate cells. The DPMC can determine respective items of textual information contained in the respective candidate cells of the group of candidate cells based at least in part on the results of the analysis (e.g., character recognition analysis) of the image data representative of the respective candidate cells.

At 1306, respective relationships between the respective candidate cells can be determined based at least in part on an analysis of image data representative of the group of cells, wherein respective links between respective candidate cells that are determined to have a relationship to each other can be formed. The DPMC can determine or identify the respective relationships between the respective candidate cells based at least in part on the results of analyzing the image data representative of the group of cells. The DPMC also can form (e.g., create) and record the respective links between respective pairs of candidate cells that are determined to have a relationship to each other.

At 1308, respective column spans, respective row spans, and respective placements within the table of the respective candidate cells can be determined based at least in part on analysis of information regarding the respective relationships between the respective candidate cells and the respective links between the respective candidate cells that are determined to have a relationship to each other, and a set of rules relating to row span, column span, and row and column placement of candidate cells in a table. The DPMC can determine the respective column spans, the respective row spans, and the respective placements (e.g., row numbers, column numbers) within the table of the respective candidate cells based at least in part on the results of analyzing the information regarding the respective relationships between the respective candidate cells and the respective links between the respective candidate cells that are determined to have a relationship to each other, and application of the set of rules to such information.

At 1310, a recreated table, which can correspond to the table presented in the electronic document, can be generated based at least in part on the respective column spans, the respective row spans, and the respective placements within the table of the respective candidate cells, and the respective items of textual information contained in the respective candidate cells. The DPMC can generate the recreated table, which can correspond to the table presented in the electronic document. The recreated table can comprise respective candidate cells that can have respective column spans, respective row spans, and respective placements within the recreated table that can desirably (e.g., accurately or at least substantially accurately) correspond to respective column spans, respective row spans, and respective placements of respective cells within the table presented in the electronic document. The recreated table also can comprise the respective items of textual information in the respective candidate cells that can desirably (e.g., accurately or at least substantially accurately) correspond to respective items of textual information in the respective cells of the table.

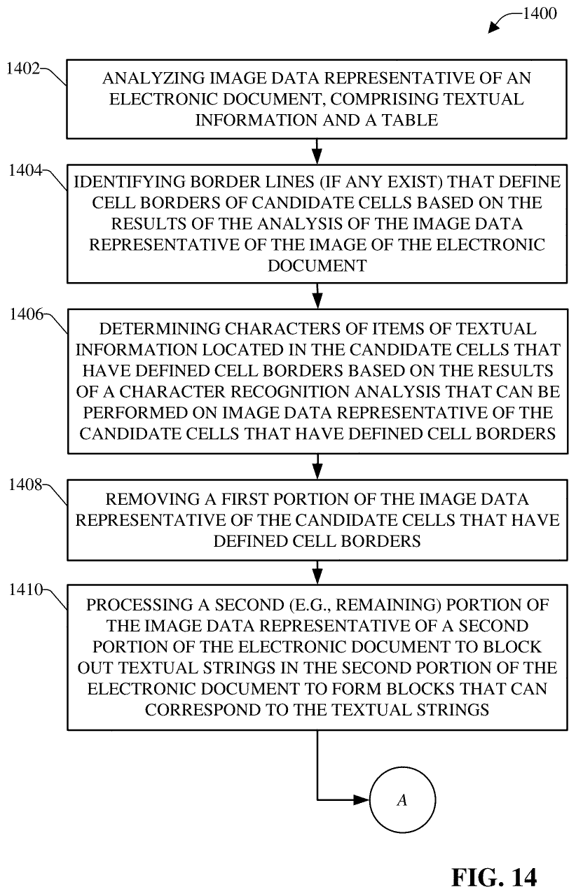

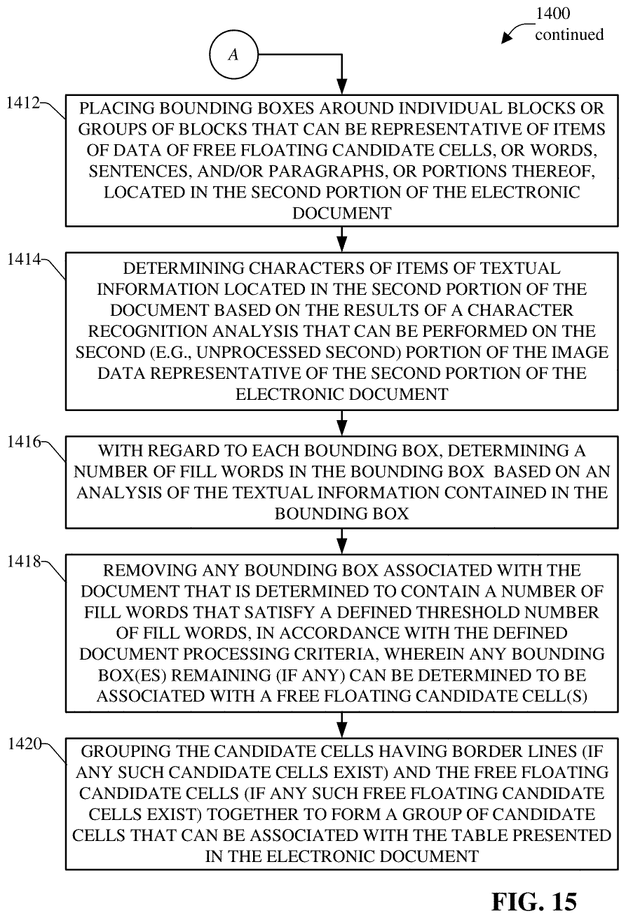

FIGS. 14 and 15 depict a flow diagram of an example, non-limiting method 1400 that can identify a group of candidate cells of a table presented in an electronic document, in accordance with various aspects and embodiments of the disclosed subject matter. The method 1400 can be implemented by a system that can comprise a DPMC, a processor component, a data store, and/or another component(s). Alternatively, or additionally, a machine-readable medium can comprise executable instructions that, when executed by a processor, facilitate performance of the operations of the method 1400.

At 1402, image data representative of an electronic document, comprising textual information and a table, can be analyzed. The DPMC can analyze the image data representative of the electronic document, which can comprise textual information and the table of cells.

At 1404, border lines (if any exist) that define cell borders of candidate cells can be identified based at least in part on the results of the analysis of the image data representative of the image of the electronic document. The DPMC can identify border lines (if any exist) that define cell borders of candidate cells based at least in part on the analysis results.

At 1406, characters of items of textual information located in the candidate cells that have defined cell borders can be determined based at least in part on the results of a character recognition analysis that can be performed on image data representative of the candidate cells that have defined cell borders. The DPMC can determine the characters of the items of textual information contained in the candidate cells that have defined cell borders based at least in part on the results of the character recognition analysis.

At 1408, a first portion of the image data representative of the candidate cells that have defined cell borders can be removed. The DPMC can remove (at least temporarily remove) the portion of the image data representative of the candidate cells (e.g., bordered candidate cells) that have defined cell borders, including the border lines that define such candidate cells and/or the items of data associated with (e.g., contained in) such candidate cells. The first portion of the image data can relate to a first portion (e.g., first region) of the electronic document where the bordered candidate cells (e.g., candidate cells having the defined cell borders) are determined to be located.

At 1410, a second (e.g., remaining) portion of the image data representative of a second portion of the electronic document can be processed to block out textual strings in the second portion of the electronic document to form blocks that can correspond to the textual strings. The DPMC can process the second portion of the image data representative of the second portion (e.g., second region) of the electronic document to block out the textual strings in the second portion of the electronic document to form the blocks that can correspond to the textual strings. The blocking out of the textual strings can render the textual characters of the textual strings indistinguishable.

At this point, the method 1400 can proceed to reference point A, wherein, as depicted in FIG. 15, the method 1400 can proceed from reference point A.

Proceeding from reference point A, at 1412, bounding boxes can be placed around individual blocks or groups of blocks that can be representative of items of data of free floating candidate cells, or words, sentences, and/or paragraphs, or portions thereof, located in the second portion of the electronic document. The DPMC can place (e.g., insert or form) the bounding boxes around the respective individual blocks or groups of blocks that can be representative of the items of data of free floating candidate cells, or words, sentences, and/or paragraphs, or portions thereof, located in the second portion of the electronic document.

At 1414, characters of items of textual information located in the second portion of the document can be determined based at least in part on the results of a character recognition analysis that can be performed on the second (e.g., unprocessed second) portion of the image data representative of the second portion of the electronic document. The DPMC can determine the characters of the items of textual information located in the second portion of the document based at least in part on the results of the character recognition analysis, wherein the second portion of the document can or may comprise one or more free floating candidate cells (if any are determined to exist in the electronic document) that can or may be part of the table, words, sentences, and/or paragraphs located in the second portion of the electronic document. The DPMC can place the respective characters of the respective items of textual information located in the second portion of the document in the respective (e.g., corresponding) bounding boxes that had been associated with the respective individual blocks or groups of blocks that can be representative of the items of data of free floating candidate cells, or words, sentences, and/or paragraphs, or portions thereof.

At 1416, with regard to each bounding box, a number of fill words in the bounding box can be determined based at least in part on an analysis of the textual information contained in the bounding box. With regard to each bounding box, the DPMC can determine the number of fill words in the bounding box based at least in part on an analysis of the textual information contained in the bounding box, in accordance with the defined document processing criteria. The document processing criteria can indicate or specify which words and/or which types or words are or can be considered to be fill words. For example, the defined document processing criteria can indicate or specify that words such as “a”, “of”, “for”, “the”, “are”, “on”, “in”, or other determiners, prepositions, conjunctions, or other desired types of words that can be considered fill words.

At 1418, any bounding box associated with the document that is determined to contain a number of fill words that satisfy a defined threshold number of fill words can be removed, in accordance with the defined document processing criteria, wherein any bounding box(es) remaining (if any) can be determined to be associated with a free floating candidate cell(s). With regard to each bounding box, based at least in part on the number of fill words determined to be contained in the bounding box and the defined threshold number of fill words, the DPMC can determine whether to remove the bounding box associated with the document. When the defined threshold (e.g., maximum threshold) number of fill words is determined to be satisfied (e.g., breached; or met or exceeded), this can indicate the bounding box can contain, or at least has a relatively high probability of containing, words, sentences, or paragraphs, or a portion thereof, that are not part of a candidate cell (e.g., free floating candidate cell), as more fully described herein. With regard to each bounding box, if the DPMC determines that the number of fill words determined to be in the bounding box does not satisfy (e.g., is less than) the defined threshold number of fill words, the DPMC can determine that such bounding box can be, or at least can have a relatively high probability of being, representative of a free floating candidate cell. With regard to each bounding box, if, instead, the DPMC determines that the number of fill words determined to be in the bounding box does satisfy (e.g., breaches; or meets or exceeds) the defined threshold number of fill words, the DPMC can determine that such bounding box can be, or at least can have a relatively high probability of being, representative of words, sentence, or paragraph, or portion thereof, that is not representative of a free floating candidate cell. For any bounding box determined to satisfy the defined threshold number of fill words, the DPMC can remove such bounding box and associated information (e.g., words, sentence, or paragraph, or portion thereof) from the electronic document (e.g., from the image data associated with the electronic document).

For instance, the DPMC can filter out, from the second portion of the image data (e.g., of the second portion of the document), a third portion of the image data (e.g., one or more bounding boxes and associated information) relating to words, sentences, and/or paragraphs determined to be located in the second portion of the image data to remove such words, sentences, and/or paragraphs. The DPMC can filter out (e.g., remove) the third portion of the image data relating to the words, sentences, and/or paragraphs located in the second portion of the image data from the second portion of the image data to filter out the words, sentences, and/or paragraphs, and can have the textual information (e.g., textual characters) of the free floating candidate cells (if any are determined to exist in the electronic document) remain in the second portion of the image data (e.g., the second portion of the document).

At 1420, the candidate cells having border lines (if any such candidate cells exist) and the free floating candidate cells (if any such free floating candidate cells exist) can be grouped together to form a group of candidate cells that can be associated with the table presented in the electronic document. The DPMC can group (e.g., combine) the candidate cells having border lines (if any such candidate cells exist) and the free floating candidate cells (if any such free floating candidate cells exist) together to form the group of candidate cells that can be associated with (e.g., that can be part of, or at least potentially can be part of) the table presented in the electronic document.

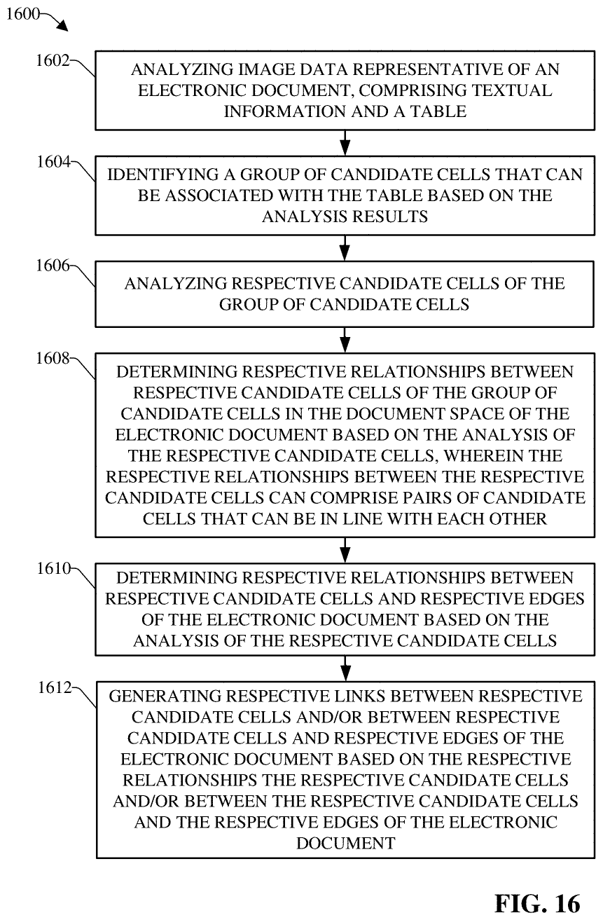

FIG. 16 illustrates a flow diagram of an example, non-limiting method 1600 that can determine respective relationships (e.g., spatial relationships) between respective candidate cells of a table presented in an electronic document, in accordance with various aspects and embodiments of the disclosed subject matter. The method 1600 can be implemented by a system that can comprise a DPMC, a processor component, a data store, and/or another component(s). Alternatively, or additionally, a machine-readable medium can comprise executable instructions that, when executed by a processor, facilitate performance of the operations of the method 1600.

At 1602, image data representative of an electronic document, comprising textual information and a table, can be analyzed. The DPMC can analyze the image data representative of the electronic document, which can comprise textual information and the table of cells.

At 1604, a group of candidate cells that can be associated with the table can be identified based at least in part on the analysis results. The DPMC can identify the group of candidate cells that can be associated with the table based at least in part on the analysis results, as more fully described herein. The group of candidate cells can comprise candidate cells that can be defined by cell borders (e.g., border lines or outlines) and/or free floating candidate cells.

At 1606, respective candidate cells of the group of candidate cells can be analyzed. At 1608, respective relationships between respective candidate cells of the group of candidate cells in the document space of the electronic document can be determined based at least in part on the analysis of the respective candidate cells, wherein the respective relationships between the respective candidate cells can comprise pairs of candidate cells that can be in line with each other. At 1610, respective relationships between respective candidate cells and respective edges of the electronic document also can be determined based at least in part on the analysis of the respective candidate cells. The DPMC can determine the respective relationships (e.g., spatial relationships) between the respective candidate cells in the document space of the electronic document based at least in part on the results of the analysis of the respective candidate cells that can be associated with (e.g., at least potentially associated with) the table. For instance, the DPMC can determine pairs of candidate cells that can be in line with each other in the horizontal direction (e.g., candidate cell and another candidate cell to the left or right of the candidate cell in the table) or vertical direction (e.g., candidate cell and another candidate cell above or below the candidate cell in the table). The DPMC also can determine respective relationships between certain candidate cells and respective edges of the electronic document. For instance, the DPMC can determine certain candidate cells that do not have an association with another candidate cell on some of their edges (e.g., sides), but can be associated with an edge of the document space of the electronic document, which can indicate that such edges of the certain candidate cells can or may be located at an edge or outer border of the table (e.g., a first column and/or first row of the table, or a last column and/or last row the table).

At 1612, respective links between respective candidate cells and/or between respective candidate cells and respective edges of the electronic document can be generated based at least in part on the respective relationships the respective candidate cells and/or between the respective candidate cells and the respective edges of the electronic document. The DPMC can generate the respective links between the respective candidate cells and/or the respective edges of the electronic document based at least in part on the respective relationships between the respective candidate cells and/or between the respective candidate cells and the respective edges of the electronic document.

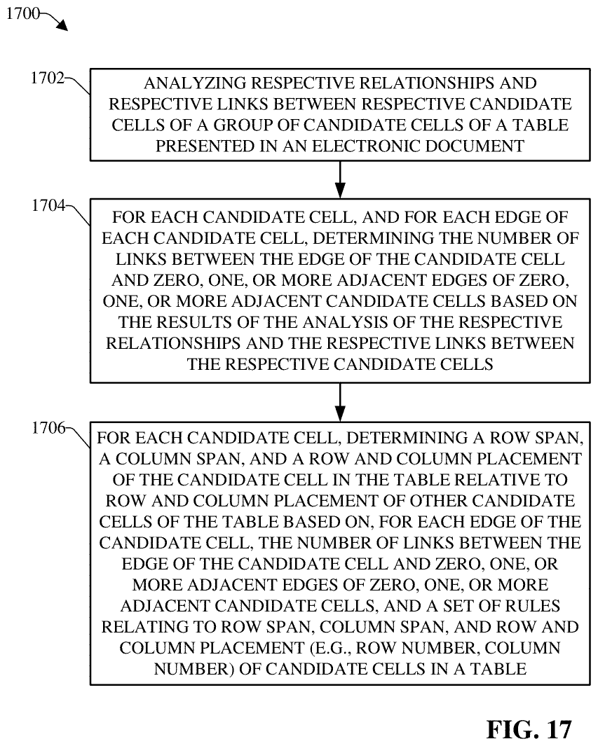

FIG. 17 depicts a flow diagram of an example, non-limiting method 1700 that can determine respective row span and/or placement, and/or respective column span and/or placement, of respective candidate cells of a group of cells of a table presented in an electronic document, in accordance with various aspects and embodiments of the disclosed subject matter. The method 1700 can be implemented by a system that can comprise a DPMC, a processor component, a data store, and/or another component(s). Alternatively, or additionally, a machine-readable medium can comprise executable instructions that, when executed by a processor, facilitate performance of the operations of the method 1700.

At 1702, respective relationships and respective links between respective candidate cells of a group of candidate cells of a table presented in an electronic document can be analyzed. The DPMC can determine the respective relationships and the respective links between the respective candidate cells of the group of candidate cells of the table presented in the electronic document, as more fully described herein. The DPMC can analyze information relating to the respective relationships and the respective links between the respective candidate cells.

At 1704, for each candidate cell, and for each edge of each candidate cell, the number of links between the edge of the candidate cell and zero, one, or more adjacent edges of zero, one, or more adjacent candidate cells can be determined based at least in part on the results of the analysis of the respective relationships and the respective links between the respective candidate cells. For each candidate cell of the group of candidate cells, and for each edge (e.g., side) of each candidate cell, the DPMC can determine the number of links between the edge of the candidate cell and zero, one, or more adjacent edges of zero, one, or more adjacent candidate cells based at least in part on the results of the analysis of the information relating to the respective relationships and the respective links between the respective candidate cells.

At 1706, for each candidate cell, a row span, a column span, and a row and column placement of the candidate cell in the table relative to row and column placement of other candidate cells of the table can be determined based at least in part on, for each edge of the candidate cell, the number of links between the edge of the candidate cell and zero, one, or more adjacent edges of zero, one, or more adjacent candidate cells, and a set of rules relating to row span, column span, and row and column placement (e.g., row number, column number) of candidate cells in a table. For each candidate cell of the group of candidate cells, the DPMC can determine the row span, the column span, and the row and column placement of the candidate cell in the table relative to the row and column placement of other candidate cells of the table based at least in part on, for each edge of the candidate cell, the number of links between the edge of the candidate cell and zero, one, or more adjacent edges of zero, one, or more adjacent candidate cells, and the set of rules relating to row span, column span, and row and column placement of candidate cells in a table, as more fully described herein. The DPMC can apply the set of rules to the information regarding, for each edge of each candidate cell, the number of links between the edge of the candidate cell and zero, one, or more adjacent edges of zero, one, or more adjacent candidate cells to facilitate determining the row span, the column span, and the row and column placement of the candidate cell in the table.

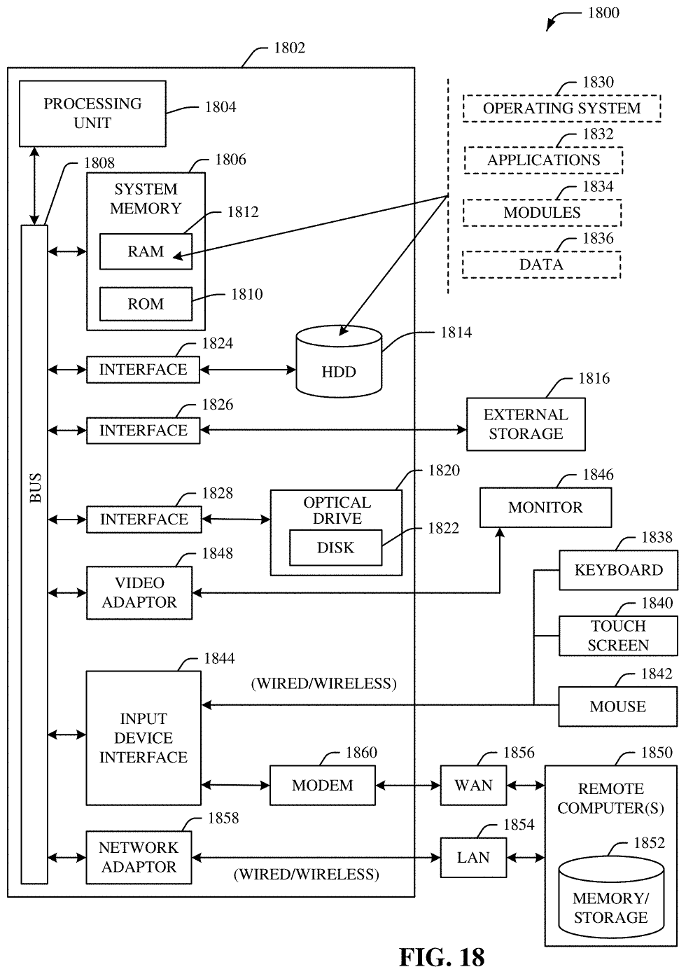

In order to provide additional context for various embodiments described herein, FIG. 18 and the following discussion are intended to provide a brief, general description of a suitable computing environment 1800 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 18, the example environment 1800 for implementing various embodiments of the aspects described herein includes a computer 1802, the computer 1802 including a processing unit 1804, a system memory 1806 and a system bus 1808. The system bus 1808 couples system components including, but not limited to, the system memory 1806 to the processing unit 1804. The processing unit 1804 can be any of various commercially available processors. Dual microprocessors and other multi-processor architectures can also be employed as the processing unit 1804.

The system bus 1808 can be any of several types of bus structure that can further interconnect to a memory bus (with or without a memory controller), a peripheral bus, and a local bus using any of a variety of commercially available bus architectures. The system memory 1806 includes ROM 1810 and RAM 1812. A basic input/output system (BIOS) can be stored in a non-volatile memory such as ROM, erasable programmable read only memory (EPROM), EEPROM, which BIOS contains the basic routines that help to transfer information between elements within the computer 1802, such as during startup. The RAM 1812 can also include a high-speed RAM such as static RAM for caching data.

The computer 1802 further includes an internal hard disk drive (HDD) 1814 (e.g., EIDE, SATA), one or more external storage devices 1816 (e.g., a magnetic floppy disk drive (FDD) 1816, a memory stick or flash drive reader, a memory card reader, etc.) and an optical disk drive 1820 (e.g., which can read or write from a CD-ROM disc, a DVD, a BD, etc.). While the internal HDD 1814 is illustrated as located within the computer 1802, the internal HDD 1814 can also be configured for external use in a suitable chassis (not shown). Additionally, while not shown in environment 1800, a solid state drive (SSD) could be used in addition to, or in place of, an HDD 1814. The HDD 1814, external storage device(s) 1816 and optical disk drive 1820 can be connected to the system bus 1808 by an HDD interface 1824, an external storage interface 1826 and an optical drive interface 1828, respectively. The interface 1824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1812, including an operating system 1830, one or more application programs 1832, other program modules 1834 and program data 1836. All or portions of the operating system, applications, modules, and/or data can also be cached in the RAM 1812. The systems and methods described herein can be implemented utilizing various commercially available operating systems or combinations of operating systems.

Computer 1802 can optionally comprise emulation technologies. For example, a hypervisor (not shown) or other intermediary can emulate a hardware environment for operating system 1830, and the emulated hardware can optionally be different from the hardware illustrated in FIG. 18. In such an embodiment, operating system 1830 can comprise one virtual machine (VM) of multiple VMs hosted at computer 1802. Furthermore, operating system 1830 can provide runtime environments, such as the Java runtime environment or the .NET framework, for applications 1832. Runtime environments are consistent execution environments that allow applications 1832 to run on any operating system that includes the runtime environment. Similarly, operating system 1830 can support containers, and applications 1832 can be in the form of containers, which are lightweight, standalone, executable packages of software that include, e.g., code, runtime, system tools, system libraries and settings for an application.

Further, computer 1802 can be enable with a security module, such as a trusted processing module (TPM). For instance with a TPM, boot components hash next in time boot components, and wait for a match of results to secured values, before loading a next boot component. This process can take place at any layer in the code execution stack of computer 1802, e.g., applied at the application execution level or at the operating system (OS) kernel level, thereby enabling security at any level of code execution.

A user can enter commands and information into the computer 1802 through one or more wired/wireless input devices, e.g., a keyboard 1838, a touch screen 1840, and a pointing device, such as a mouse 1842. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1804 through an input device interface 1844 that can be coupled to the system bus 1808, but can be connected by other interfaces, such as a parallel port, an IEEE 1394 serial port, a game port, a USB port, an IR interface, a BLUETOOTH® interface, etc.

A monitor 1846 or other type of display device can be also connected to the system bus 1808 via an interface, such as a video adapter 1848. In addition to the monitor 1846, a computer typically includes other peripheral output devices (not shown), such as speakers, printers, etc.

The computer 1802 can operate in a networked environment using logical connections via wired and/or wireless communications to one or more remote computers, such as a remote computer(s) 1850. The remote computer(s) 1850 can be a workstation, a server computer, a router, a personal computer, portable computer, microprocessor-based entertainment appliance, a peer device or other common network node, and typically includes many or all of the elements described relative to the computer 1802, although, for purposes of brevity, only a memory/storage device 1852 is illustrated. The logical connections depicted include wired/wireless connectivity to a local area network (LAN) 1854 and/or larger networks, e.g., a wide area network (WAN) 1856. Such LAN and WAN networking environments are commonplace in offices and companies, and facilitate enterprise-wide computer networks, such as intranets, all of which can connect to a global communications network, e.g., the Internet.

When used in a LAN networking environment, the computer 1802 can be connected to the local network 1854 through a wired and/or wireless communication network interface or adapter 1858. The adapter 1858 can facilitate wired or wireless communication to the LAN 1854, which can also include a wireless access point (AP) disposed thereon for communicating with the adapter 1858 in a wireless mode.

When used in a WAN networking environment, the computer 1802 can include a modem 1860 or can be connected to a communications server on the WAN 1856 via other means for establishing communications over the WAN 1856, such as by way of the Internet. The modem 1860, which can be internal or external and a wired or wireless device, can be connected to the system bus 1808 via the input device interface 1844. In a networked environment, program modules depicted relative to the computer 1802 or portions thereof, can be stored in the remote memory/storage device 1852. It will be appreciated that the network connections shown are example and other means of establishing a communications link between the computers can be used.

When used in either a LAN or WAN networking environment, the computer 1802 can access cloud storage systems or other network-based storage systems in addition to, or in place of, external storage devices 1816 as described above. Generally, a connection between the computer 1802 and a cloud storage system can be established over a LAN 1854 or WAN 1856, e.g., by the adapter 1858 or modem 1860, respectively. Upon connecting the computer 1802 to an associated cloud storage system, the external storage interface 1826 can, with the aid of the adapter 1858 and/or modem 1860, manage storage provided by the cloud storage system as it would other types of external storage. For instance, the external storage interface 1826 can be configured to provide access to cloud storage sources as if those sources were physically connected to the computer 1802.

The computer 1802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” and the like can refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “Node B (NB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “entity,” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

Systems, methods and/or machine-readable storage media for facilitating a two-stage downlink control channel for 5G systems are provided herein. Legacy wireless systems such as LTE, Long-Term Evolution Advanced (LTE-A), High Speed Packet Access (HSPA) etc. use fixed modulation format for downlink control channels. Fixed modulation format implies that the downlink control channel format is always encoded with a single type of modulation (e.g., quadrature phase shift keying (QPSK)) and has a fixed code rate. Moreover, the forward error correction (FEC) encoder uses a single, fixed mother code rate of ⅓ with rate matching. This design does not take into the account channel statistics. For example, if the channel from the BS device to the mobile device is very good, the control channel cannot use this information to adjust the modulation, code rate, thereby unnecessarily allocating power on the control channel. Similarly, if the channel from the BS to the mobile device is poor, then there is a probability that the mobile device might not be able to decode the information received with only the fixed modulation and code rate. As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can comprise, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise performing cell identification to identify candidate cells that can be associated with a table of a document, performing a character recognition analysis on information relating to a document, performing cell relationship identification to identify relationships between candidate cells, determining cell placement of candidate cells in a table, extracting or recreating a table of a document, transmitting or receiving data, establishing a connection between devices, determining intermediate results toward obtaining a result, or other actions. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, the DPMC, an interface component, a cell identifier component, a character recognition component, an AI component, a text blocking component, a bounding box component, a cell relationship identifier component, a cell placement component, an operations manager component, processors, sensors, antennae, audio and/or visual output devices, or other devices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
determining, by a system comprising a processor, a group of candidate cells associated with a table in an electronic document based on a first analysis of image data representative of an image of the electronic document;
determining, by the system, respective items of textual information contained in respective candidate cells of the group of candidate cells based on a second analysis of a portion of the image data representative of the respective candidate cells;
determining, by the system, respective relationships between the respective candidate cells based on a third analysis of the portion of the image data representative of the group of cells, wherein, for respective pairs of candidate cells of the respective candidate cells that are determined to have a relationship to each other, respective links are created between the respective pairs of candidate cells;
determining, by the system, respective column spans, respective row spans, and respective column and row placements of the respective candidate cells based on a fourth analysis of information regarding the respective relationships between the respective candidate cells and the respective links between the respective pairs of candidate cells, and based on a group of rules relating to row span, column span, and column and row placement of candidate cells; and
generating, by the system, a recreated table that corresponds to the table based on the respective items of textual information contained in the respective candidate cells, and based on the respective column spans, the respective row spans, and the respective column and row placements of the respective candidate cells.

2. The method of claim 1, wherein the determining of the group of candidate cells associated with the table comprises:
identifying, by the system, border lines that define cell borders of at least some of the respective candidate cells that are bordered candidate cells based on the first analysis of the image data.

3. The method of claim 2, wherein the portion of the image data is a first portion of the image data, and wherein the method further comprises:
removing, by the system, a second portion of the image data representative of the bordered candidate cells that have the cell borders defined by the border lines, wherein the bordered candidate cells are determined to be associated with a first region of the electronic document;
processing, by the system, a third portion of the image data representative of a second region of the electronic document to block out textual strings located in the second region of the electronic document to form blocks that correspond to the textual strings, wherein processed image data is generated based on the processing;
inserting, by the system, respective bounding boxes around respective individual blocks or respective groups of blocks;
determining, by the system, respective characters, respective data items, respective words, respective sentences, or respective paragraphs in the respective bounding boxes based on the third portion of the image data;
replacing, by the system, the respective individual blocks or the respective groups of blocks with the respective characters, the respective data items, the respective words, the respective sentences, or the respective paragraphs;
analyzing, by the system, the respective characters, the respective data items, the respective words, the respective sentences, or the respective paragraphs in the respective bounding boxes;
removing, by the system, one or more bounding boxes that are determined to contain a number of fill words that satisfy a defined threshold number of fill words, in accordance with a defined document processing criterion that indicates what constitutes a fill word and indicates the defined threshold number, to generate a remaining portion of the image data, wherein the remaining portion of the image data relates to one or more free floating candidate cells that do not have the cell borders defined by the border lines, and wherein the group of candidate cells comprises the bordered candidate cells and the one or more free floating candidate cells.

4. The method of claim 1, wherein the second analysis of the portion of the image data representative of the respective candidate cells is a character recognition analysis of the portion of the image data representative of the respective candidate cells.

5. The method of claim 1, wherein the respective pairs of candidate cells comprise a first pair of candidate cells, wherein the group of candidate cells comprise a first candidate cell and a second candidate cell, and wherein the determining of the respective relationships between the respective candidate cells based on the third analysis of the portion of the image data representative of the group of candidate cells comprises:
determining an edge of the first candidate cell is adjacent to an edge of the second candidate cell;
determining the first candidate cell and the second candidate cell are the first pair of candidate cells that have a first relationship with each other based on the determining that the edge of the first candidate cell is adjacent to the edge of the second candidate cell; and
in response to determining that the first candidate cell and the second candidate cell have the first relationship with each other, creating a first link between the edge of the first candidate cell and the edge of the second candidate cell, wherein the respective links comprise the first link.

6. The method of claim 5, wherein the edge of the first candidate cell is a first edge of the first candidate cell, wherein the respective pairs of candidate cells comprise a second pair of candidate cells, wherein the group of candidate cells comprise a third candidate cell, wherein the respective links comprise a second link, and wherein the method further comprises:
determining the first edge of the first candidate cell is adjacent to an edge of the third candidate cell;
determining the first candidate cell and the third candidate cell are the second pair of candidate cells that have a second relationship with each other based on the determining that the first edge of the first candidate cell is adjacent to the edge of the third candidate cell; and
in response to determining that the first candidate cell and the third candidate cell have the second relationship with each other, creating the second link between the first edge of the first candidate cell and the edge of the third candidate cell.

7. The method of claim 6, wherein the respective pairs of candidate cells comprise a third pair of candidate cells, wherein the group of candidate cells comprise a fourth candidate cell, wherein the respective links comprise a third link, and wherein the method further comprises:
determining a second edge of the first candidate cell is adjacent to an edge of the fourth candidate cell;
determining the first candidate cell and the fourth candidate cell are the third pair of candidate cells that have a third relationship with each other based on the determining that the second edge of the first candidate cell is adjacent to the edge of the fourth candidate cell; and
in response to determining that the first candidate cell and the fourth candidate cell have the third relationship with each other, creating the third link between the second edge of the first candidate cell and the edge of the fourth candidate cell.

8. The method of claim 1, wherein the respective candidate cells comprise a candidate cell, and wherein the determining of the respective column spans, the respective row spans, and the respective column and row placements of the respective candidate cells based on the fourth analysis of the information regarding the respective relationships between the respective candidate cells and the respective links between the respective pairs of candidate cells, and based on the group of rules, comprises:
determining a column span of the candidate cell based on a first number of links determined to be between a first edge of the candidate cell and a first subgroup of candidate cells of the group of candidate cells, and based on a first rule of the group of rules, wherein the first rule indicates that the column span is at least a number of columns that corresponds to the first number of links; and
determining a row span of the candidate cell based on a second number of links determined to be between a second edge of the candidate cell and a second subgroup of candidate cells of the group of candidate cells, and based on a second rule of the group of rules, wherein the second rule indicates that the row span is at least a number of rows that corresponds to the second number of links.

9. The method of claim 1, wherein the respective candidate cells comprise a candidate cell, and wherein the determining of the respective column spans, the respective row spans, and the respective column and row placements of the respective candidate cells based on the fourth analysis of the information regarding the respective relationships between the respective candidate cells and the respective links between the respective pairs of candidate cells, and based on the group of rules, comprises:
determining a column and row placement of the candidate cell based on which edges of the candidate cell are determined to have links to other candidate cells of the group of candidate cells, and based on a rule of the group of rules, wherein the rule indicates the column and row placement of the candidate cell within the recreated table based on which edges of the candidate cell have links to the other candidate cells.

10. The method of claim 9, further comprising:
based on the fourth analysis, determining, by the system, that an edge of the candidate cell does not have any link to any of the other candidate cells of the group of candidate cells, wherein the edge is determined to be associated with a top edge of the electronic document based on an orientation of the respective items of textual information,
wherein the determining of the column and row placement of the candidate cell comprises determining that the column placement of the candidate cell is in a first column of the recreated table based on the determining that the edge of the candidate cell does not have any link to any of the other candidate cells, the edge being determined to be associated with the top edge of the electronic document, and the rule indicating that the column placement of the candidate cell is in the first column of the recreated table under conditions where the edge of the candidate cell does not have any link to any of the other candidate cells and the edge of the candidate cell is associated with the top edge of the electronic document.

11. The method of claim 9, further comprising:
based on the fourth analysis, determining, by the system, that an edge of the candidate cell does not have any link to any of the other candidate cells of the group of candidate cells, wherein the edge is determined to be associated with a left edge of the electronic document based on an orientation of the respective items of textual information,
wherein the determining of the column and row placement of the candidate cell comprises determining that the row placement of the candidate cell is in a first row of the recreated table based on the determining that the edge of the candidate cell does not have any link to any of the other candidate cells, the edge being determined to be associated with the left edge of the electronic document, and the rule indicating that the row placement of the candidate cell is in the first row of the recreated table under conditions where the edge of the candidate cell does not have any link to any of the other candidate cells and the edge of the candidate cell is associated with the left edge of the electronic document.

12. The method of claim 9, wherein the candidate cell is a first candidate cell, wherein the respective cells comprise the first candidate cell, a second candidate cell, and a third candidate cell, wherein the respective links comprise a first link and a second link, and wherein the method further comprises:
based on the fourth analysis, determining, by the system, that a top edge of the first candidate cell has the first link to a bottom edge of the second candidate cell, wherein the top edge of the first candidate cell and the bottom edge of the second candidate cell are determined based on an orientation of the respective items of textual information, wherein no other candidate cell is determined to be located above the second candidate cell in a document space associated with the electronic document, and wherein the second candidate cell is determined to span one row;
based on the fourth analysis, determining, by the system, that a left edge of the first candidate cell has the second link to a right edge of the third candidate cell, wherein the left edge of the first candidate cell and the right edge of the third candidate cell are determined based on the orientation of the respective items of textual information, wherein no other candidate cell is determined to be located left of the third candidate cell in the document space associated with the electronic document, and wherein the third candidate cell is determined to span one column,
wherein the determining of the column and row placement of the first candidate cell comprises determining that the column and row placement of the first candidate cell is at a second column and a second row of the recreated table based on the rule indicating that the column and row placement of the candidate cell is in the second column and the second row of the recreated table under conditions where the top edge of the first candidate cell has the first link to the bottom edge of the second candidate cell, no other candidate cell is located above the second candidate cell in the document space, the left edge of the first candidate cell has the second link to the right edge of the third candidate cell, and no other candidate cell is located to the left of the third candidate cell in the document space.

13. The method of claim 1, wherein the electronic document comprises a single document layer on which the table, the respective items of textual information, and a background of the electronic document reside, wherein the background surrounds the table and the respective items of textual information, wherein the respective items of textual information in the respective candidate cells of the recreated table are editable and searchable, and wherein a first arrangement of the respective candidate cells of the recreated table replicates a second arrangement of cells of the table.

14. A system, comprising:
a processor; and
a memory that stores executable instructions that, when executed by the processor, facilitate performance of operations, comprising:
determining a group of candidate cells associated with a table in an electronic document based on a first analysis of image information representative of an image of the electronic document;
determining respective items of data associated with respective candidate cells of the group of candidate cells based on a second analysis of a portion of the image information representative of the respective candidate cells;
determining respective associations between the respective candidate cells based on a third analysis of the portion of the image information, wherein, for respective pairs of candidate cells of the respective candidate cells that are determined to have an association with each other, respective connections are formed between the respective pairs of candidate cells;
determining respective column spans, respective row spans, and respective table positions of the respective candidate cells based on a fourth analysis of information regarding the respective associations between the respective candidate cells and the respective connections between the respective pairs of candidate cells, and based on a group of rules relating to row span, column span, and table positions of candidate cells; and
generating an extracted table that corresponds to the table based on the respective items of data associated with the respective candidate cells, and based on the respective column spans, the respective row spans, and the respective table positions of the respective candidate cells.

15. The system of claim 14, wherein the determining of the group of candidate cells associated with the table presented in the electronic document comprises determining that the group of candidate cells comprises a first candidate cell or a second candidate cell based on the first analysis of the image information, wherein the first candidate cell is defined by outlines that form borders of the first candidate cell, and wherein the second candidate cell does not have an outline on at least one side of the second candidate cell.

16. The system of claim 14, wherein the respective pairs of candidate cells comprise a pair of candidate cells, wherein the group of candidate cells comprise a first candidate cell and a second candidate cell, and wherein the determining of the respective associations between the respective candidate cells based on the third analysis of the portion of the image information comprises:
determining that a side of the first candidate cell neighbors a side of the second candidate cell;
determining that the first candidate cell and the second candidate cell are the pair of candidate cells that have a relationship with each other based on the determining that the side of the first candidate cell neighbors the side of the second candidate cell; and
in response to determining that the first candidate cell and the second candidate cell have the relationship with each other, forming a connection between the side of the first candidate cell and the side of the second candidate cell, wherein the respective connections comprise the connection.

17. The system of claim 14, wherein the respective candidate cells comprise a candidate cell, and wherein the determining of the respective column spans, the respective row spans, and the respective table positions of the respective candidate cells based on the fourth analysis of the information regarding the respective associations between the respective candidate cells and the respective connections between the respective pairs of candidate cells, and based on the group of rules, comprises:
determining a column span of the candidate cell based on a first number of connections determined to be between a first side of the candidate cell and a first subgroup of candidate cells of the group of candidate cells, and based on a first rule of the group of rules, wherein the first rule indicates that the column span is at least a number of columns that corresponds to the first number of connections; and
determining a row span of the candidate cell based on a second number of connections determined to be between a second side of the candidate cell and a second subgroup of candidate cells of the group of candidate cells, and based on a second rule of the group of rules, wherein the second rule indicates that the row span is at least a number of rows that corresponds to the second number of connections.

18. The system of claim 14, wherein the respective candidate cells comprise a candidate cell, and wherein the determining of the respective column spans, the respective row spans, and the respective table positions of the respective candidate cells based on the fourth analysis of the information regarding the respective associations between the respective candidate cells and the respective connections between the respective pairs of candidate cells, and based on the group of rules, comprises:
determining a table position, comprising a row position and a column position, of the candidate cell based on which sides of the candidate cell are determined to have connections to other candidate cells of the group of candidate cells, and based on a rule of the group of rules, wherein the rule indicates the table position of the candidate cell within the extracted table based on which sides of the candidate cell have connections to the other candidate cells.

19. A non-transitory machine-readable medium, comprising executable instructions that, when executed by a processor, facilitate performance of operations, comprising:
determining a group of candidate table entry regions associated with a table contained in an electronic document based on a first evaluation of image data representative of an image of the electronic document;
determining respective items of data associated with respective candidate table entry regions of the group of candidate table entry regions based on a second evaluation of a portion of the image data representative of the respective candidate table entry regions;
determining respective relationships between the respective candidate table entry regions based on a third evaluation of the portion of the image data, wherein, for respective pairs of candidate table entry regions of the respective candidate table entry regions that are determined to have a relationship with each other, respective links are established between the respective pairs of candidate table entry regions;
determining respective column extents, respective row extents, and respective row and column positions of the respective candidate table entry regions based on a fourth evaluation of relationship information regarding the respective relationships between the respective candidate table entry regions and the respective links between the respective pairs of candidate table entry regions, and based on a group of rules relating to row extent, column extent, and row and column positions of candidate table entry regions; and
generating an extracted table that corresponds to the table based on the respective items of data associated with the respective candidate table entry regions, and based on the respective column spans, the respective row spans, and the respective row and column positions of the respective candidate table entry regions.

20. The non-transitory machine-readable medium of claim 19, wherein the respective candidate table entry regions comprise a candidate table entry region, and wherein the determining of the respective column extents, the respective row extents, and the respective row and column positions of the respective candidate table entry regions based on the fourth evaluation of the relationship information regarding the respective relationships between the respective candidate table entry regions and the respective links between the respective pairs of candidate table entry regions, and based on the group of rules, comprises:
determining a column extent of the candidate table entry region based on a first number of links between a first edge of the candidate table entry region and a first subgroup of candidate table entry regions of the group of candidate table entry regions, and based on a first rule of the group of rules, wherein the first rule indicates that the column extent is at least a number of columns that corresponds to the first number of links;
determining a row extent of the candidate table entry region based on a second number of links between a second edge of the candidate table entry region and a second subgroup of candidate table entry regions of the group of candidate table entry regions, and based on a second rule of the group of rules, wherein the second rule indicates that the row extent is at least a number of rows that corresponds to the second number of links; and
determining a row and column position of the candidate table entry region based on which edges of the candidate table entry region have links to other candidate table entry regions of the group of candidate table entry regions, and based on a third rule of the group of rules, wherein the third rule indicates the row and column position of the candidate table entry region within the extracted table based on which edges of the candidate table entry region have links to the other candidate table entry regions.
